(19) United States
(12) Patent Application Publication
(10) Pub. No.: US 2013/0248762 A1
(43) Pub. Date: Sep. 26, 2013

(54) LIQUID-CRYSTALLINE MEDIUM

(71) Applicants: Harald Hirschmann, Darmstadt (DE); Michael Wittek, Erzhausen (DE); Markus Czanta, Darmstadt (DE); Brigitte Schuler, Grossostheim (DE); Volker Reiffenrath, Rossdorf (DE)

(72) Inventors: Harald Hirschmann, Darmstadt (DE); Michael Wittek, Erzhausen (DE); Markus Czanta, Darmstadt (DE); Brigitte Schuler, Grossostheim (DE); Volker Reiffenrath, Rossdorf (DE)

(73) Assignee: Merck Patent GmbH, Darmstadt (DE)

(21) Appl. No.: 13/988,881

(22) PCT Filed: Nov. 14, 2011
(86) PCT No.: PCT/EP2011/005728

§ 371 Date: May 22, 2013

(30) Foreign Application Priority Data
Nov. 27, 2010 (DE) 10 2010 052 796.3

(51) Int. Cl. C09K 19/30; C09K 19/34

(52) U.S. Cl. CPC C09K 19/3003; C09K 19/3066; C09K 19/3402
USPC 252/299.61; 252/299.63; 585/27; 568/631

(57) ABSTRACT

The invention relates to liquid-crystalline media comprising at least one compound of the formula I,

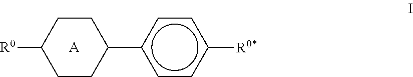

in which
R⁰, R⁰* and ring A have the meanings indicated in Claim 1,
and to electro-optical liquid-crystal displays, in particular for TN-TFT, OCB, IPS, PS-IPS, FFS, PS-FFS and positive VA applications.

The present invention relates to a liquid-crystalline medium (LC medium), to the use thereof for electro-optical purposes, and to LC displays containing this medium.

Liquid crystals are used principally as dielectrics in display devices, since the optical properties of such substances can be modified by an applied voltage. Electro-optical devices based on liquid crystals are extremely well known to the person skilled in the art and can be based on various effects. Examples of such devices are cells having dynamic scattering, DAP (deformation of aligned phases) cells, guest/host cells, TN cells having a twisted nematic structure, STN (“supertwisted nematic”) cells, SBE (“superbirefringence effect”) cells and OMI (“optical mode interference”) cells. The commonest display devices are based on the Schadt-Helfrich effect and have a twisted nematic structure. In addition, there are also cells which work with an electric field parallel to the substrate and liquid-crystal plane, such as, for example, IPS (“in-plane switching”) cells. In particular, TN, STN, FFS (fringe field switching) and IPS cells are currently commercially interesting areas of application for the media according to the invention.

The liquid-crystal materials must have good chemical and thermal stability and good stability to electric fields and electromagnetic radiation. Furthermore, the liquid-crystal materials should have low viscosity and produce short addressing times, low threshold voltages and high contrast in the cells.

They should furthermore have a suitable mesophase, for example a nematic or cholesteric mesophase for the above-mentioned cells, at the usual operating temperatures, i.e. in the broadest possible range above and below room temperature. Since liquid crystals are generally used as mixtures of a plurality of components, it is important that the components are readily miscible with one another. Further properties, such as the electrical conductivity, the dielectric anisotropy and the optical anisotropy, have to satisfy various requirements depending on the cell type and area of application. For example, materials for cells having a twisted nematic structure should have positive dielectric anisotropy and low electrical conductivity.

For example, for matrix liquid-crystal displays with integrated non-linear elements for switching individual pixels (MLC displays), media having large positive dielectric anisotropy, broad nematic phases, relatively low birefringence, very high specific resistance, good UV and temperature stability and low vapour pressure are desired.

Matrix liquid-crystal displays of this type are known. Examples of non-linear elements which can be used to individually switch the individual pixels are active elements (i.e. transistors). The term “active matrix” is then used, where a distinction can be made between two types:
1. MOS (metal oxide semiconductor) or other diodes on silicon wafers as substrate.
2. Thin-film transistors (TFTs) on a glass plate as substrate.

The use of single-crystal silicon as substrate material restricts the display size, since even modular assembly of various part-displays results in problems at the joints.

In the case of the more promising type 2, which is preferred, the electro-optical effect used is usually the TN effect. A distinction is made between two technologies: TFTs comprising compound semiconductors, such as, for example, CdSe, or TFTs based on polycrystalline or amorphous silicon. Intensive work is being carried out worldwide on the latter technology.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays usually operate as TN cells with crossed polarisers in transmission and are backlit.

The term MLC displays here encompasses any matrix display with integrated non-linear elements, i.e., besides the active matrix, also displays with passive elements, such as varistors or diodes (MIM=metal-insulator-metal).

MLC displays of this type are particularly suitable for TV applications (for example pocket televisions) or for high-information displays for computer applications (laptops) and in automobile or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff, Paris; STROMER, M., Proc. Eurodisplay 84, September 1984: Design of Thin Film Transistors for Matrix Addressing of Television Liquid Crystal Displays, pp. 145 ff, Paris]. With decreasing resistance, the contrast of an MLC display deteriorates, and the problem of after-image elimination may occur. Since the specific resistance of the liquid-crystal mixture generally drops over the life of an MLC display owing to interaction with the interior surfaces of the display, a high (initial) resistance is very important in order to obtain acceptable lifetimes. In particular in the case of low-volt mixtures, it was hitherto impossible to achieve very high specific resistance values. It is furthermore important that the specific resistance exhibits the smallest possible increase with increasing temperature and after heating and/or UV exposure. The low-temperature properties of the mixtures from the prior art are also particularly disadvantageous. It is demanded that no crystallisation and/or smectic phases occur, even at low temperatures, and the temperature dependence of the viscosity is as low as possible. The MLC displays from the prior art thus do not satisfy today's requirements.

Besides liquid-crystal displays which use backlighting, i.e. are operated transmissively and if desired transflectively, reflective liquid-crystal displays are also particularly interesting. These reflective liquid-crystal displays use the ambient light for information display. They thus consume significantly less energy than backlit liquid-crystal displays having a corresponding size and resolution. Since the TN effect is characterised by very good contrast, reflective displays of this type can even be read well in bright ambient conditions. This is already known of simple reflective TN displays, as used, for example, in watches and pocket calculators. However, the principle can also be applied to high-quality, higher-resolution active matrix-addressed displays, such as, for example, TFT displays. Here, as already in the transmissive TFT-TN displays which are generally conventional, the use of liquid crystals of low birefringence (Δn) is necessary in order to achieve low optical retardation (d·Δn). This low optical retardation results in usually acceptable low viewing-angle dependence of the contrast (cf. DE 30 22 818). In reflective displays, the use of liquid crystals of low birefringence is even more important than in transmissive displays since the effective layer thickness through which the light passes is approximately twice as large in reflective displays as in transmissive displays having the same layer thickness.

TV and video applications require displays having fast response times in order to be able to reproduce multimedia content, such as, for example, films and video games, near-realistically. Such short response times can be achieved, in particular, if liquid-crystal media having low values of the viscosity, in particular the rotational viscosity γ₁, and having high optical anisotropy (Δn) are used.

Thus, there continues to be a great demand for MLC displays having very high specific resistance at the same time as a large working-temperature range, short response times, even at low temperatures, and a low threshold voltage which do not exhibit these disadvantages or only do so to a lesser extent.

In the case of TN (Schadt-Helfrich) cells, media are desired which facilitate the following advantages in the cells:
extended nematic phase range (in particular down to low temperatures)
switchability at extremely low temperatures (outdoor use, automobiles, avionics)
increased resistance to UV radiation (longer life)
low threshold voltage.

The media available from the prior art do not enable these advantages to be achieved while simultaneously retaining the other parameters.

In the case of supertwisted (STN) cells, media are desired which facilitate greater multiplexability and/or lower threshold voltages and/or broader nematic phase ranges (in particular at low temperatures). To this end, a further widening of the available parameter latitude (clearing point, smectic-nematic transition or melting point, viscosity, dielectric parameters, elastic parameters) is urgently desired.

Modern LCD flat-panel screens require ever-faster response times in order to be able to reproduce multimedia content, such as, for example, films, video games, etc., near-realistically. These in turn require nematic liquid-crystal mixtures which have very low rotational viscosity γ₁ with high optical anisotropy Δn. In order to obtain the requisite rotational viscosities of the liquid-crystal mixtures, the employed concentrations of individual components frequently have to be maximised. This in turn frequently results in the LC mixtures being unstable at low temperatures, i.e., for example, crystallising out, and converting into an undesired smectic phase. If these problems occur in a display, this generally results in failure of the display and thus in irreparable damage to the LCD flat-panel screen.

The invention is based on the object of providing media, in particular for MLC, TN, STN, OCB, positive VA, FFS or IPS displays of this type, which have the desired properties indicated above and do not exhibit the disadvantages indicated above or only do so to a lesser extent. In particular, the LC media should have fast response times and low rotational viscosities at the same time as high birefringence. In addition, the LC media should have a high clearing point, high dielectric anisotropy and a low threshold voltage.

It has now been found that this object can be achieved if liquid-crystal mixtures comprising one or more compounds of the formula I are used. Even in low concentrations in the LC mixture, the compounds of the formula I suppress the transition to smectic phases.

The invention relates to a liquid-crystalline medium, characterised in that it comprises one or more compounds of the formula I,

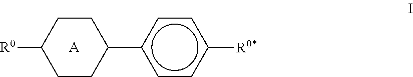

in which
R⁰ and R⁰* each, independently of one another, denote an alkyl or alkoxy radical having 1 to 15 C atoms, where, in addition, one or more CH₂ groups in these radicals may each be replaced, independently of one another, by —C≡C—, —CF₂O—, —CH═CH—,

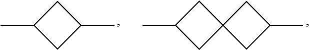

—O—, —CO—O—, —O—CO— in such a way that O atoms are not linked directly to one another, and in which, in addition, one or more H atoms may be replaced by halogen,
ring A denotes a 1,4-cyclohexylene ring or 1,4-cyclohexenylene ring, in which, in addition, one or two CH₂ groups may be replaced by —O— and/or —S—.

Surprisingly, it has been found that LC media comprising compounds of the formula I have a very good ratio of rotational viscosity γ₁ and clearing point, a high value of the optical anisotropy and high birefringence Δn, as well as fast response times, a low threshold voltage, a high clearing point, high positive dielectric anisotropy and a broad nematic phase range and are very stable at low temperatures (≦−20° C.). Furthermore, the compounds of the formula I are very readily soluble in liquid-crystalline media. The compounds of the formula I are known, for example, from EP 122389.

The compounds of the formula I have a broad range of applications. Depending on the choice of substituents, they can serve as base materials of which liquid-crystalline media are predominantly composed; however, liquid-crystalline base materials from other classes of compound can also be added to the compounds of the formula I in order, for example, to modify the dielectric and/or optical anisotropy of a dielectric of this type and/or to optimise its threshold voltage and/or its viscosity.

If R⁰ and/or R⁰* in the formulae above and below denote an alkyl radical and/or an alkoxy radical, this may be straight-chain or branched. It is preferably straight-chain, has 2, 3, 4, 5, 6 or 7 C atoms and accordingly preferably denotes ethyl, propyl, butyl, pentyl, hexyl, heptyl, ethoxy, propoxy, butoxy, pentoxy, hexyloxy or heptyloxy, furthermore methyl, octyl, nonyl, decyl, undecyl, dodecyl, tridecyl, tetradecyl, pentadecyl, methoxy, octyloxy, nonyloxy, decyloxy, undecyloxy, dodecyloxy, tridecyloxy or tetradecyloxy.

Oxaalkyl preferably denotes straight-chain 2-oxapropyl (=methoxymethyl), 2- (=ethoxymethyl) or 3-oxabutyl (=2-methoxyethyl), 2-, 3- or 4-oxapentyl, 2-, 3-, 4- or 5-oxahexyl, 2-, 3-, 4-, 5- or 6-oxaheptyl, 2-, 3-, 4-, 5-, 6- or 7-oxaoctyl, 2-, 3-, 4-, 5-, 6-, 7- or 8-oxanonyl, 2-, 3-, 4-, 5-, 6-, 7-, 8- or 9-oxadecyl.

If R⁰ and/or R⁰* denote an alkyl radical in which one CH₂ group has been replaced by —CH═CH—, this may be straight-chain or branched. It is preferably straight-chain and has 2 to 10 C atoms. Accordingly, it denotes, in particular, vinyl, prop-1- or -2-enyl, but-1-, -2- or -3-enyl, pent-1-, -2-, -3- or -4-enyl, hex-1-, -2-, -3-, -4- or -5-enyl, hept 1-, -2-, -3-, -4-, -5- or -6-enyl, oct-1-, -2-, -3-, -4-, -5-, -6- or -7-enyl, non-1-, -2-, -3-, -4-, -5-, -6-, -7- or -8-enyl, dec-1-, -2-, -3-, -4-, -5-, -6-, -7-, -8- or -9-enyl. These radicals may also be mono- or polyhalogenated.

In the compounds of the formula I, R⁰ preferably denotes an alkenyl radical, in particular CH₂═CH, CH₃CH═CH, CH₂═CHC₂H₄, C₂H₅CH═CH, in particular CH₃CH═CH or CH₂═CHC₂H₄.

R⁰* in the compounds of the formula I preferably denotes straight-chain alkyl, straight-chain alkoxy or straight-chain alkenyl, preferably having 1-3 C atoms or 2-3 C atoms respectively. R⁰* very particularly preferably denotes OCH₃, CH₃, C₂H₅, C₂H₄CH═CH₂.

The ring A in the formula I preferably denotes a 1,4-cyclohexylene ring, furthermore a dioxane or pyran ring.

Preferred compounds of the formula I are indicated below:

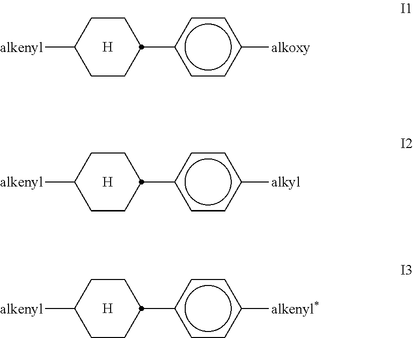

in which
alkenyl and alkenyl* each, independently of one another, denote a straight-chain alkenyl radical having 2 to 6 C atoms, preferably an alkenyl radical having a maximum of 3 C atoms,
alkoxy denotes a straight-chain alkoxy radical having 1 to 6 C atoms,
   and
alkyl denotes a straight-chain alkyl radical having 1 to 6 C atoms.

Particular preference is given to the following compounds:

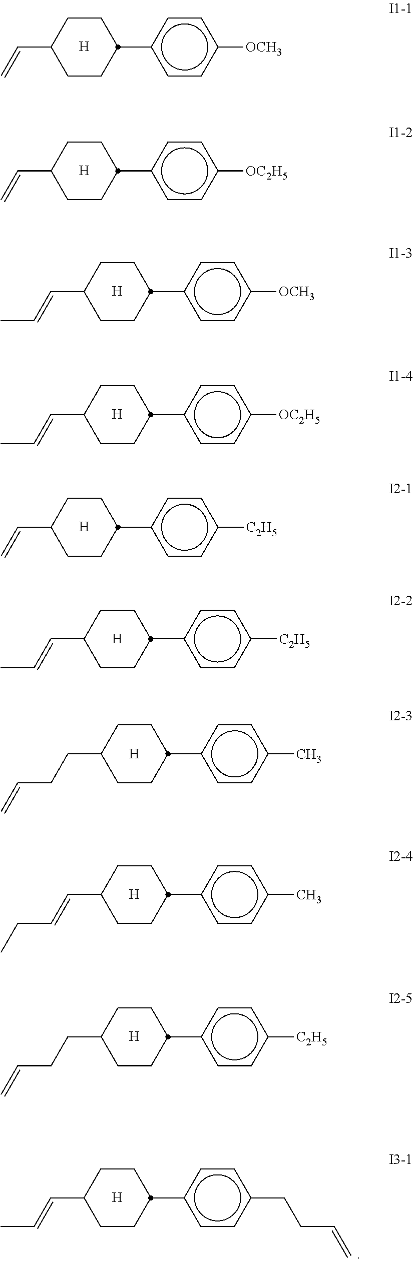

Particularly preferred compounds are the compounds of the formulae I2-2, I2-3 and I2-4.

Particular preference is given to mixtures comprising the compound of the formula I2-3.

In the pure state, the compounds of the formula I are colourless and form liquid-crystalline mesophases in a temperature range which is favourably located for electro-optical use. They are stable chemically, thermally and to light. However, the compounds are distinguished, in particular, by the fact that they suppress the smectic phases in the liquid-crystalline media.

The compounds of the formula I are prepared by methods known per se, as described in the literature (for example in the standard works, such as Houben-Weyl, Methoden der organischen Chemie [Methods of Organic Chemistry], Georg-Thieme-Verlag, Stuttgart), to be precise under reaction conditions which are known and suitable for the said reactions. Use can also be made here of variants known per se which are not mentioned here in greater detail.

Further preferred embodiments are indicated below:
The medium additionally comprises one or more neutral compounds of the formulae II and/or III,

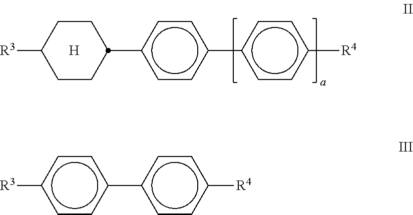

in which
A denotes 1,4-phenylene or trans-1,4-cyclohexylene,
a is 0 or 1, where, in the case where a=0, ring A denotes trans-1,4-cyclohexylene,
R³ denotes alkenyl having 2 to 9 C atoms,
and R⁴ has the meaning indicated for R⁰ in formula I and preferably denotes alkyl having 1 to 12 C atoms or alkenyl having 2 to 9 C atoms.
The compounds of the formula II are preferably selected from the following formulae:

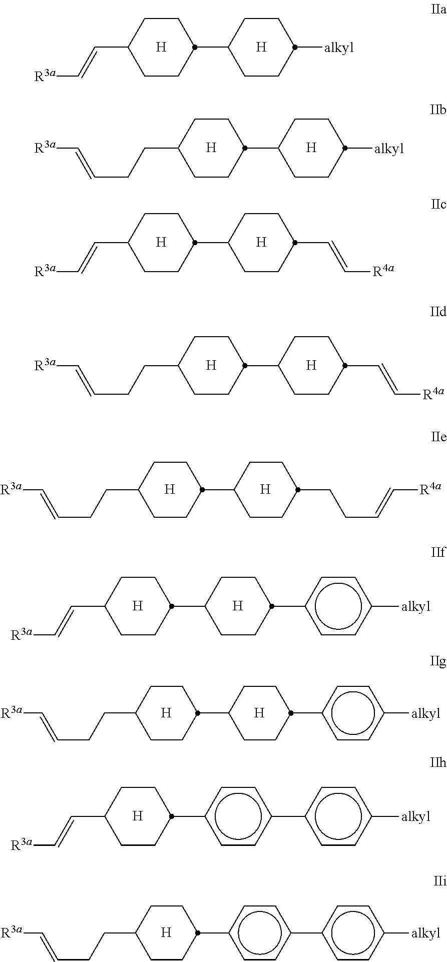

in which R^{3a} and R^{4a} each, independently of one another, denote H, CH₃, C₂H₅ or C₃H₇, and “alkyl” denotes a straight-chain alkyl group having 1 to 8 C atoms. Particular preference is given to compounds of the formulae IIa and IIf, in particular in which R^{3a} denotes H or CH₃, and compounds of the formula IIc, in particular in which R^{3a} and R^{4a} denote H, CH₃ or C₂H₅.
Preference is furthermore given to compounds of the formula II which have a non-terminal double bond in the alkenyl side chain:

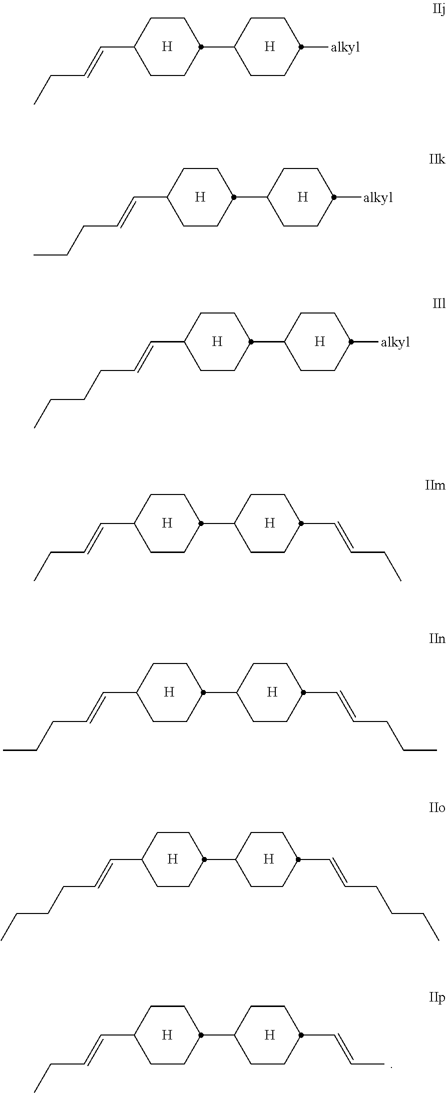

Very particularly preferred compounds of the formula II are the compounds of the formulae

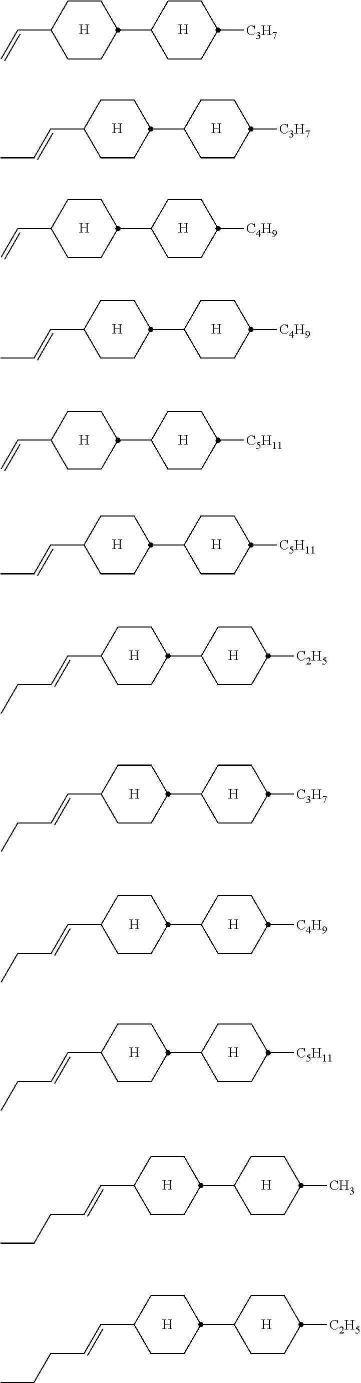

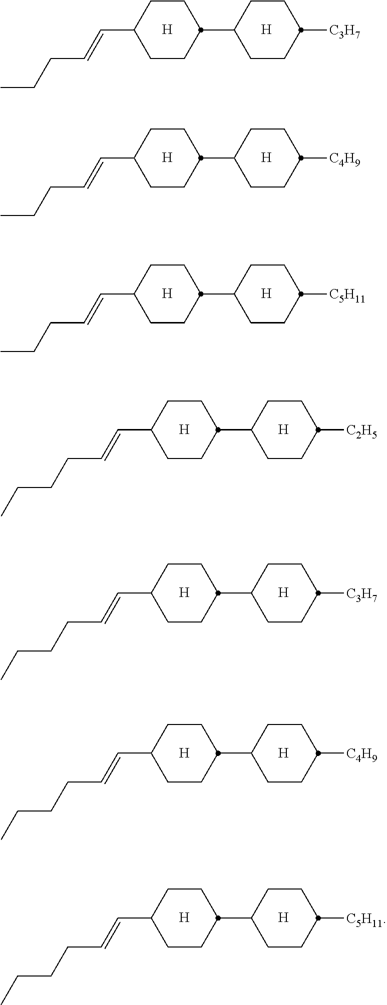

Besides one or more compounds of the formula I, the liquid-crystalline media according to the invention particularly preferably comprise 5-70% by weight of compounds of the formulae

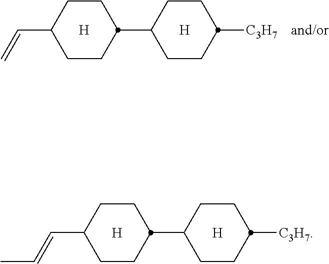

The compounds of the formula III are preferably selected from the following formulae:

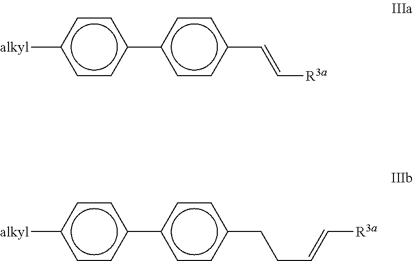

in which “alkyl” and R^{3a} have the meanings indicated above, and R^{3a} preferably denotes H or CH₃. Particular preference is given to compounds of the formula IIIb;
The medium preferably additionally comprises one or more compounds selected from the formulae IV to VIII,

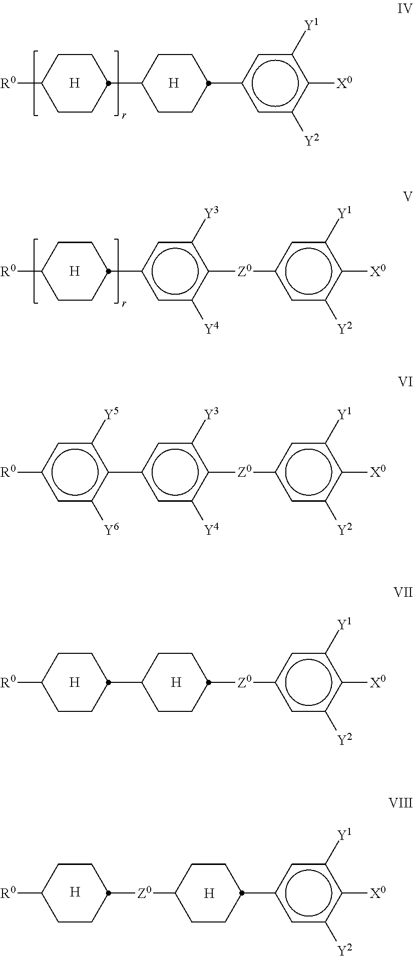

in which
R⁰ has the meanings indicated in formula I,
X⁰ denotes F, Cl, a mono- or polyfluorinated alkyl or alkoxy radical, in each case having 1 to 6 C atoms, or a mono- or polyfluorinated alkenyl or alkenyloxy radical, in each case having 2 to 6 C atoms,
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
r denotes 0 or 1.
In the above formulae, X⁰ is preferably F, Cl or a mono- or polyfluorinated alkyl or alkoxy radical having 1, 2 or 3 C atoms or a mono- or polyfluorinated alkenyl radical or alkenyloxy radical having 2 or 3 C atoms. X⁰ is particularly preferably F, Cl, CF₃, CHF₂, OCF₃, OCHF₂, OCFHCF₃, OCFHCHF₂, OCFHCHF₂, OCF₂CH₃, OCF₂CHF₂, OCF₂CHF₂, OCF₂CF₂CHF₂, OCF₂CF₂CH₂F, OCFHCF₂CF₃, OCFHCF₂CHF₂, OCH═CF₂, OCF═CF₂, OCF₂CHFCF₃, OCF₂CF₂CF₃, OCF₂CF₂CClF₂, OCClFCF₂CF₃, CF═CF₂, CF═CHF, OCH═CF₂, OCF═CF₂ or CH═CF₂. X° very particularly preferably denotes F or OCF₃.
In the compounds of the formulae IV to VIII, X⁰ preferably denotes F or OCF₃, furthermore OCHF₂, CF₃, CF₂H, Cl, OCH═CF₂. R⁰ is preferably straight-chain alkyl or alkenyl having up to 6 C atoms.
The compounds of the formula IV are preferably selected from the following formulae:

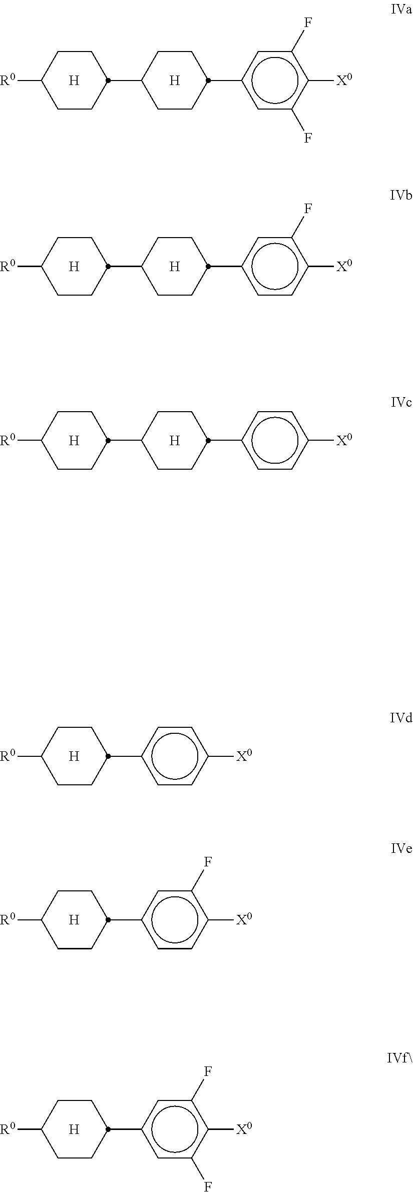

in which R⁰ and X⁰ have the meanings indicated above.
In formula IV, R⁰ preferably denotes alkyl having 1 to 8 C atoms and X⁰ preferably denotes F, Cl, OCHF₂ or OCF₃, furthermore OCH═CF₂. In the compound of the formula IVb, R⁰ preferably denotes alkyl or alkenyl. In the compound of the formula IVd, X⁰ preferably denotes Cl, furthermore F.
The compounds of the formula V are preferably selected from the formulae Va to Vj,

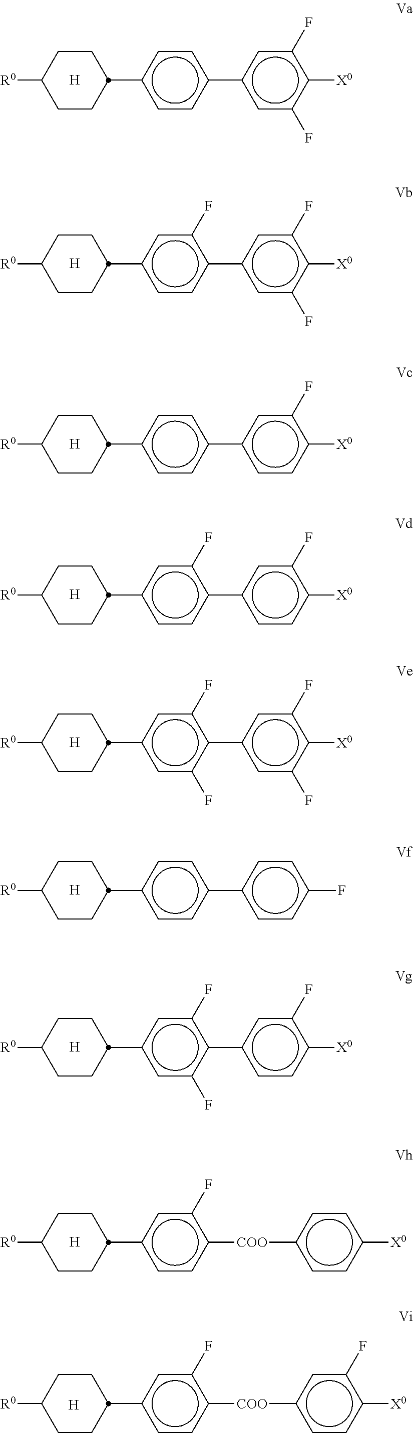

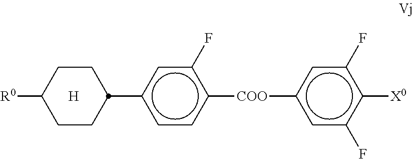

in which R⁰ and X⁰ have the meanings indicated above. In formula V, R⁰ preferably denotes alkyl having 1 to 8 C atoms and X⁰ preferably denotes F;
The medium comprises one or more compounds of the formula VI-1,

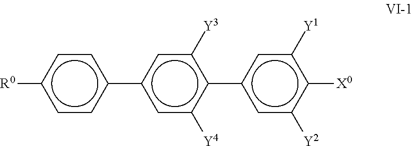

particularly preferably those selected from the following formulae:

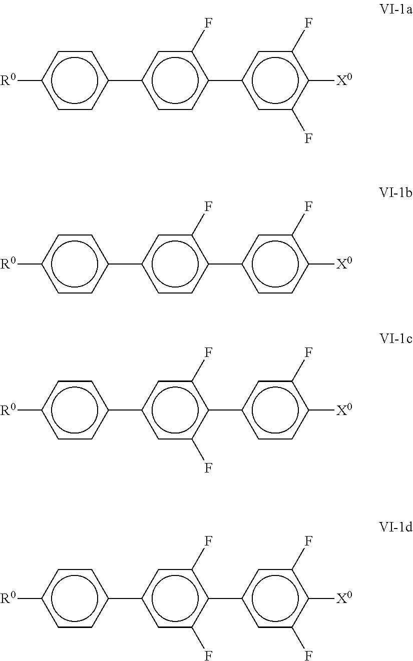

in which R⁰ and X⁰ have the meanings indicated above.
In formula VI, R⁰ preferably denotes alkyl having 1 to 8 C atoms and X⁰ preferably denotes F, furthermore OCF₃.
The medium comprises one or more compounds of the formula VI-2,

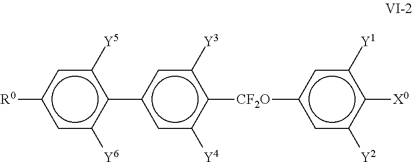

particularly preferably those selected from the following formulae:

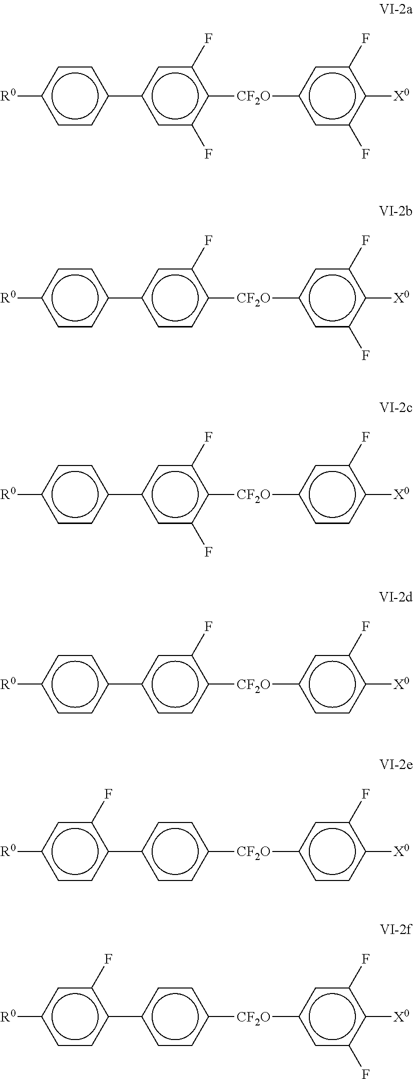

in which R⁰ and X⁰ have the meanings indicated above.
In formula VI, R⁰ preferably denotes alkyl having 1 to 8 C atoms and X⁰ preferably denotes F;
The medium preferably comprises one or more compounds of the formula VII in which Z⁰ denotes —CF₂O—, —CH₂CH₂— or —COO—, particularly preferably those selected from the following formulae:

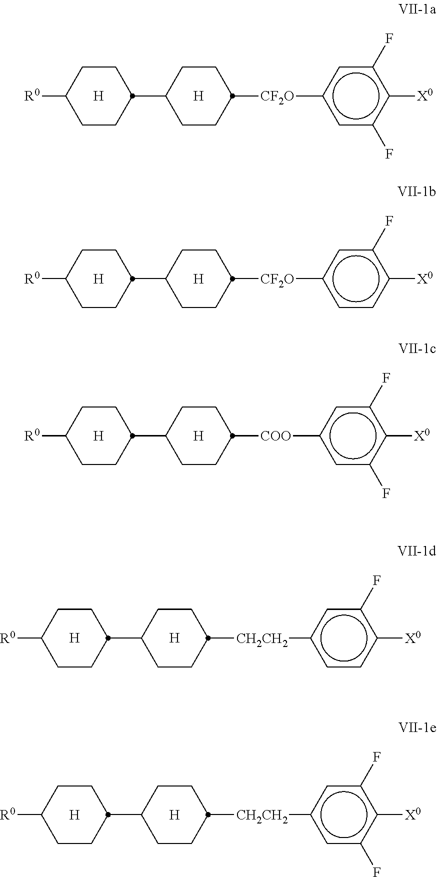

in which R⁰ and X⁰ have the meanings indicated above. In formula VII, R⁰ preferably denotes alkyl having 1 to 8 C atoms and X⁰ preferably denotes F, furthermore OCF₃.
The compounds of the formula VIII are preferably selected from the following formulae:

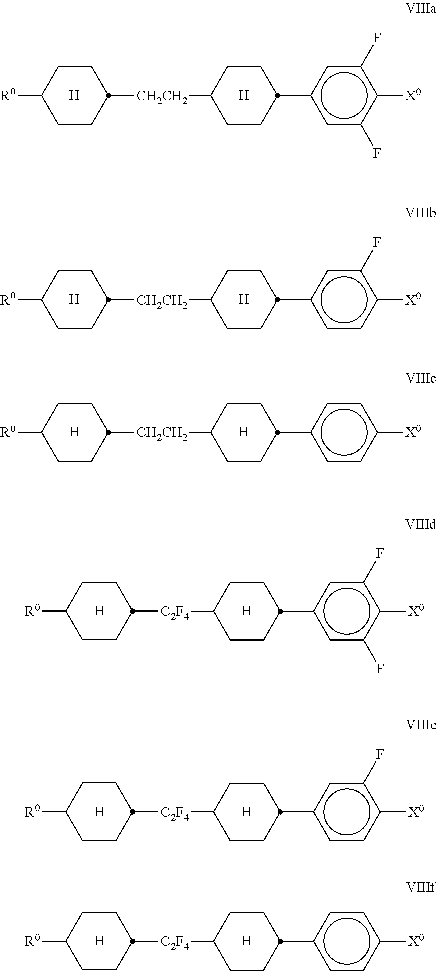

in which R⁰ and X⁰ have the meanings indicated above. In formula VIII, R⁰ preferably denotes a straight-chain alkyl radical having 1 to 8 C atoms. X⁰ preferably denotes F.
The medium additionally comprises one or more compounds of the following formula:

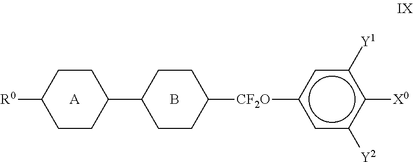

in which R⁰, X⁰, Y¹ and Y² have the meanings indicated above, and

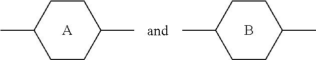

each, independently of one another, denote

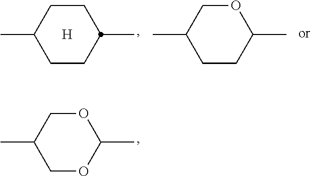

where rings A and B do not both simultaneously denote 1,4-cyclohexylene;
The compounds of the formula IX are preferably selected from the following formulae:

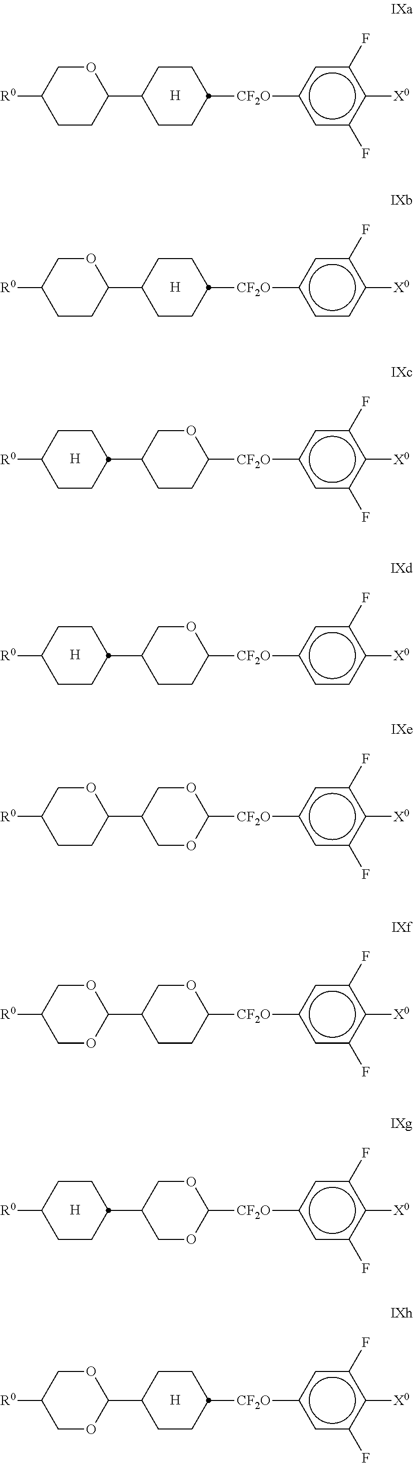

in which R⁰ and X⁰ have the meanings indicated above. In formula IX, R⁰ preferably denotes alkyl having 1 to 8 C atoms and X⁰ preferably denotes F. Particular preference is given to compounds of the formula IXa;
The medium additionally comprises one or more compounds selected from the following formulae:

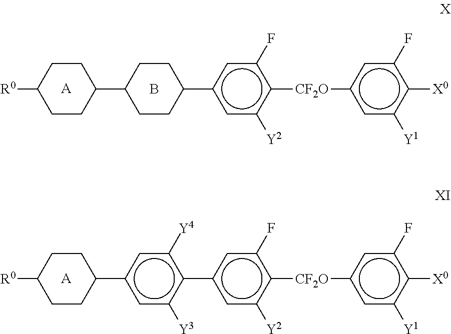

in which R⁰, X⁰ and Y¹⁻⁴ have the meanings indicated in formula I, and

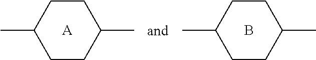

each, independently of one another,

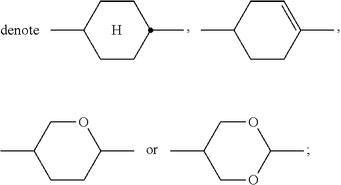

The compounds of the formulae X and XI are preferably selected from the following formulae:

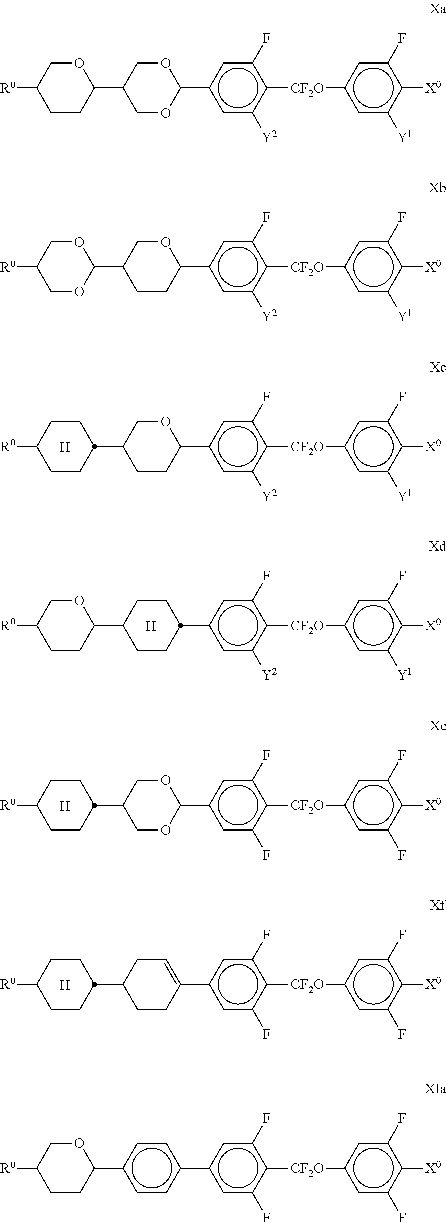

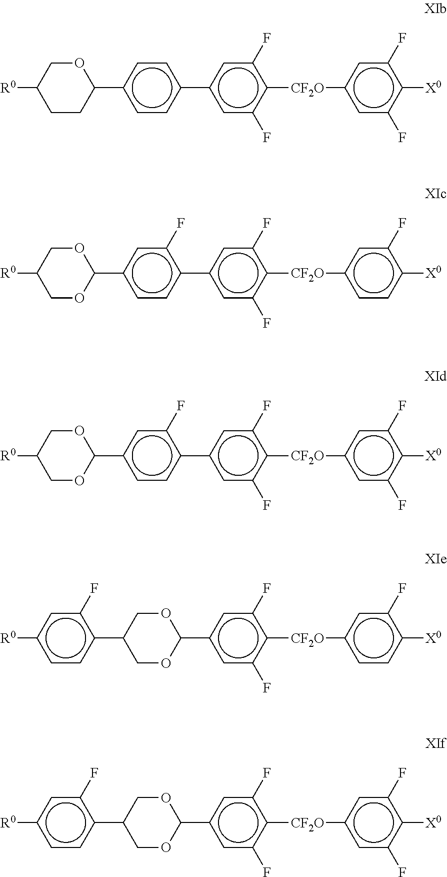

in which R⁰ and X⁰ have the meanings indicated above. R⁰ preferably denotes alkyl having 1 to 8 C atoms and X⁰ preferably denotes F. Particularly preferred compounds are those in which Y¹ denotes F and Y² denotes H or F, preferably F;
The medium additionally comprises one or more compounds of the following formula:

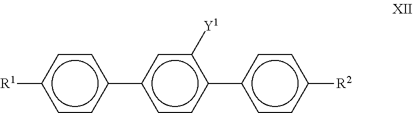

in which R¹ and R² each, independently of one another, denote n-alkyl, alkoxy, oxaalkyl, fluoroalkyl, alkenyloxy or alkenyl, each having up to 9 C atoms, and preferably each, independently of one another, denote alkyl having 1 to 8 C atoms. Y¹ denotes H or F.
Preferred compounds of the formula XII are the compounds of the formulae

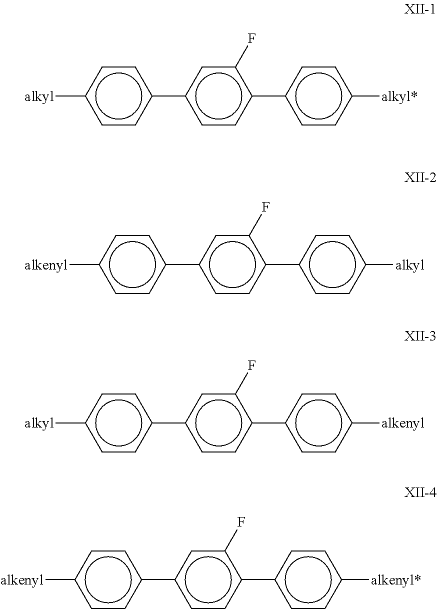

in which
alkyl and alkyl* each, independently of one another, denote a straight-chain alkyl radical having 1 to 6 C atoms, and
alkenyl and alkenyl* each, independently of one another, denote a straight-chain alkenyl radical having 2 to 6 C atoms.
Particular preference is given to the compounds of the formulae XIII-1 and XII-3.
A particularly preferred compound of the formula XII-3 is the compound of the formula XII-3a:

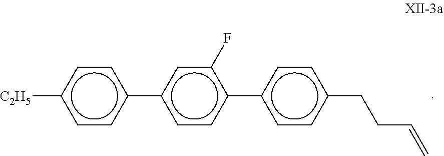

The compounds of the formula XII are preferably employed in amounts of 3-30% by weight.
The medium additionally comprises one or more compounds selected from the following formulae:

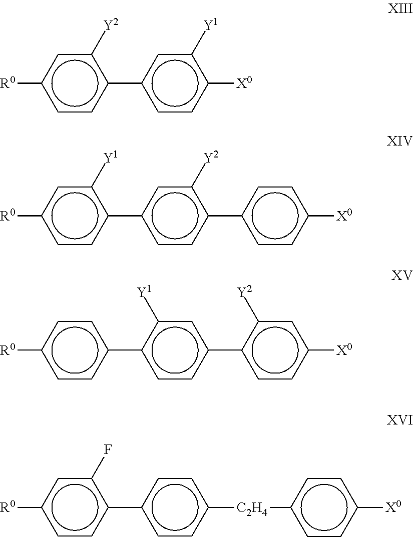

in which R⁰, X⁰, Y¹ and Y² have the meanings indicated above. R⁰ preferably denotes alkyl having 1 to 8 C atoms and X⁰ preferably denotes F or Cl;
The compounds of the formulae XIII and XIV are preferably selected from the compounds of the formulae

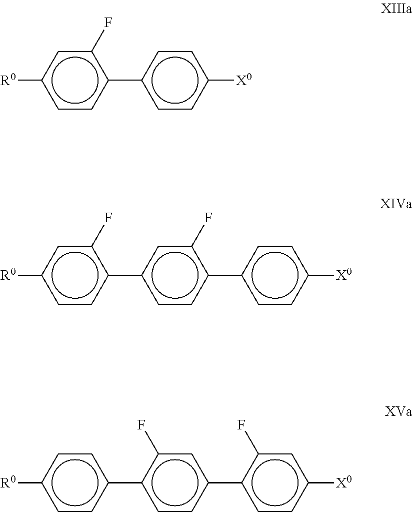

in which R⁰ and X⁰ have the meanings indicated above. R⁰ preferably denotes alkyl having 1 to 8 C atoms. In the compounds of the formula XIII, X⁰ preferably denotes F or Cl.
The medium additionally comprises one or more compounds of the formulae D1, D2 and/or D3

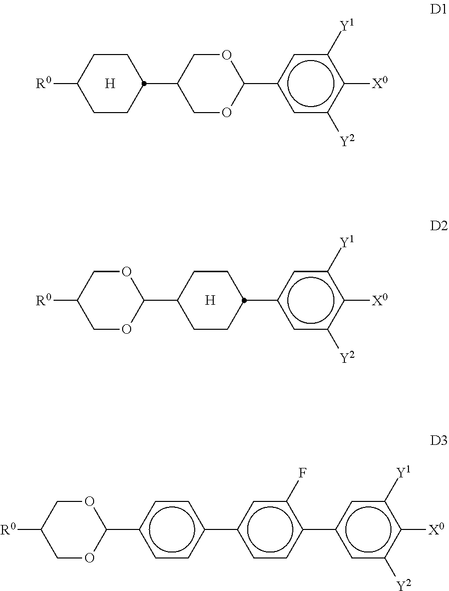

in which Y¹, Y², R⁰ and X⁰ have the meanings indicated above. R⁰ preferably denotes alkyl having 1 to 8 C atoms and X⁰ preferably denotes F.
Particular preference is given to compounds of the formulae

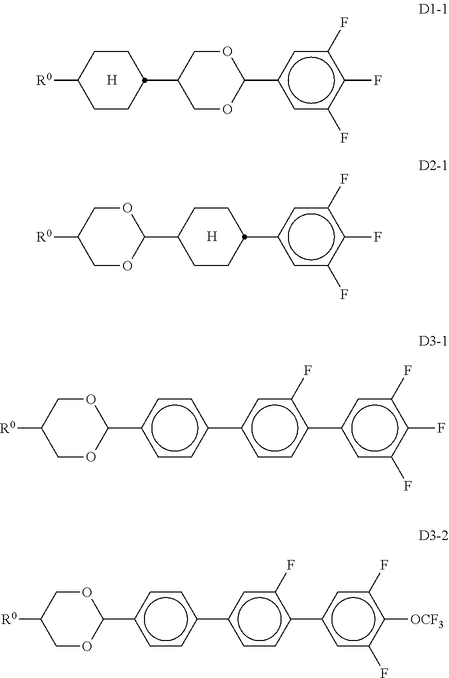

in which R⁰ has the meanings indicated above and preferably denotes straight-chain alkyl having 1 to 6 C atoms, in particular C₂H₅, n-C₃H₇ or n-C₅H₁₁.
The medium additionally comprises one or more compounds of the following formulae:

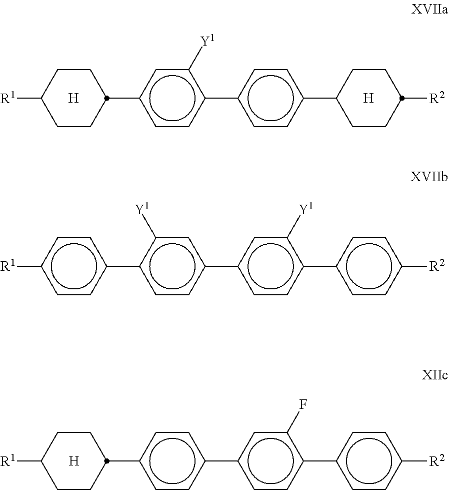

in which Y¹, R¹ and R² have the meanings indicated above. R¹ and R² preferably each, independently of one another, denote alkyl having 1 to 8 C atoms; Y¹ preferably denotes F;
The medium additionally comprises one or more compounds of the following formula:

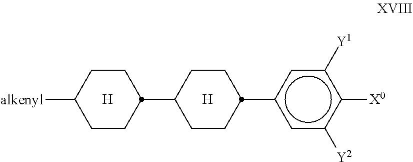

in which X⁰, Y¹ and Y² have the meanings indicated above, and “alkenyl” denotes C₂₋₇-alkenyl. Particular preference is given to compounds of the following formula:

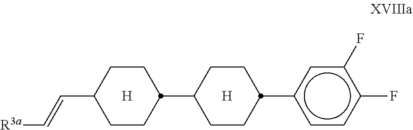

in which R^{3a} has the meaning indicated above and preferably denotes H;
The medium additionally comprises one or more tetracyclic compounds selected from the formulae XIX to XXVII,

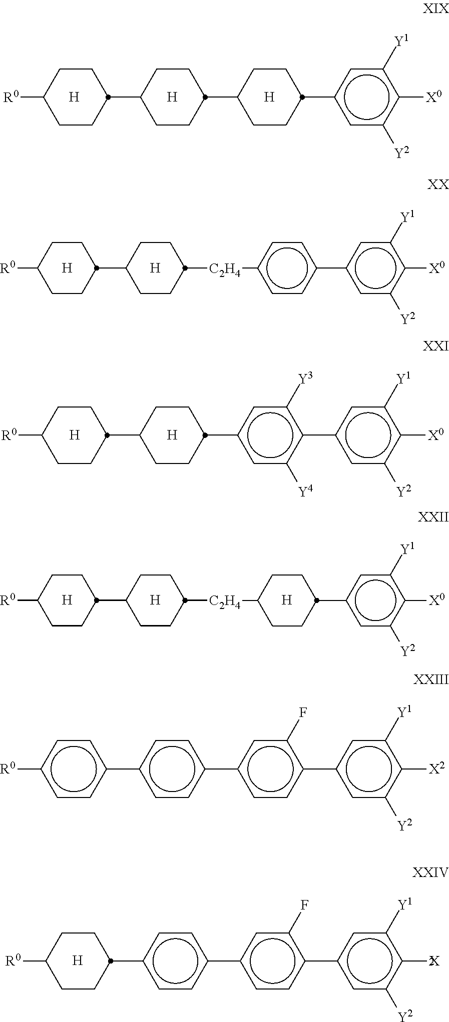

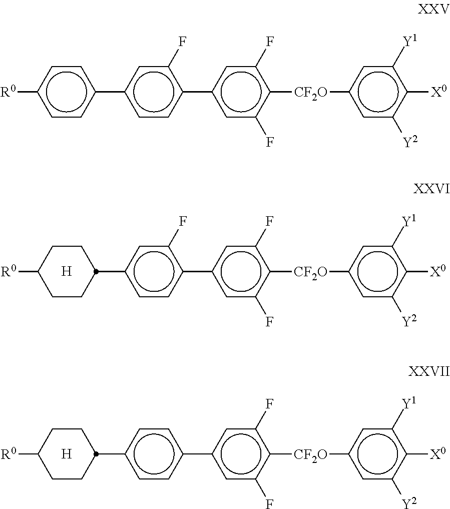

in which Y¹⁻⁴, R⁰ and X⁰ each, independently of one another, have one of the meanings indicated above. X⁰ is preferably F, Cl, CF₃, OCF₃ or OCHF₂. R⁰ preferably denotes alkyl, alkoxy, oxaalkyl, fluoroalkyl or alkenyl, each having up to 8 C atoms.
In the formulae given above and below,

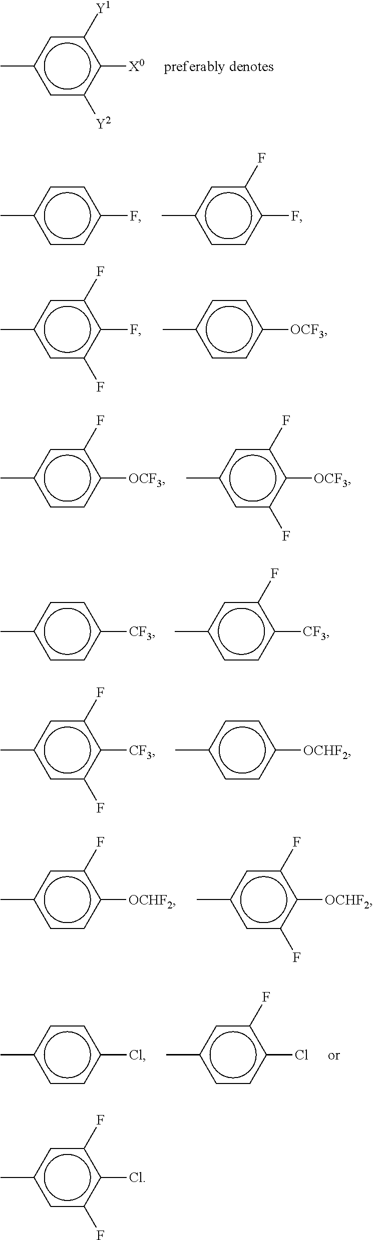

R⁰ is preferably straight-chain alkyl or alkenyl having 2 to 7 C atoms;
X⁰ is preferably F, furthermore OCF₃, C₁ or CF₃;
The medium preferably comprises one, two or three compounds of the formula I; in particular at least one compound of the formula 12.
The medium preferably comprises one or more compounds selected from the group of the compounds of the formulae I, II, III, V, VI-1, VI-2, XII, XIII, XIV, XVII, XXIII, XXV.
The medium preferably comprises one or more compounds of the formula VI-1;
The medium preferably comprises one or more compounds of the formula VI-2;
The medium preferably comprises 0.5-25% by weight, preferably 1-20% by weight, particularly preferably 1-10% by weight, of compounds of the formula I;
The proportion of compounds of the formulae II-XXVII in the mixture as a whole is preferably 20 to 99% by weight;
The medium preferably comprises 25-80% by weight, particularly preferably 30-70% by weight, of compounds of the formulae II and/or III;
The medium preferably comprises 5-40% by weight, particularly preferably 10-30% by weight, of compounds of the formula V;
The medium preferably comprises 3-30% by weight, particularly preferably 6-25% by weight, of compounds of the formula VI-1;
The medium preferably comprises 2-30% by weight, particularly preferably 4-25% by weight, of compounds of the formula VI-2;
The medium comprises 5-40% by weight, particularly preferably 10-30% by weight, of compounds of the formula XII;
The medium preferably comprises 1-25% by weight, particularly preferably 2-15% by weight, of compounds of the formula XIII;
The medium preferably comprises 5-45% by weight, particularly preferably 10-35% by weight, of compounds of the formula XIV;
The medium preferably comprises 1-20% by weight, particularly preferably 2-15% by weight, of compounds of the formula XVI.
The medium additionally comprises one or more compounds of the formulae St-1 to St-3,

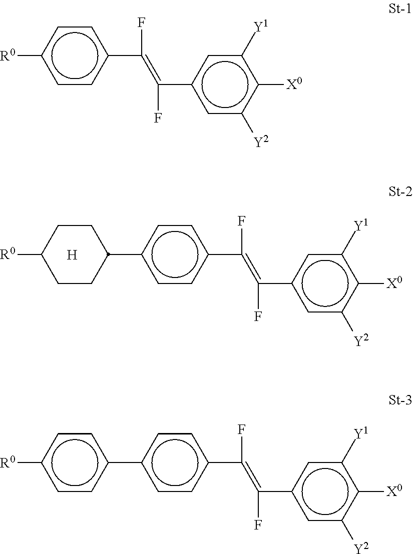

in which R⁰, Y¹, Y² and X⁰ have the meanings indicated above. R⁰ preferably denotes straight-chain alkyl, preferably having 1-6 C atoms. X⁰ is preferably F or OCF₃. Y¹ preferably denotes F. Y² preferably denotes F. Preference is furthermore given to compounds in which Y¹═F and Y²═H. The compounds of the formulae St-1 to St-3 are preferably employed in the mixtures according to the invention in a concentration of 3-30% by weight, in particular 5-25% by weight.
The medium additionally comprises one or more pyrimidine or pyridine compounds of the formulae Py-1 to Py-5,

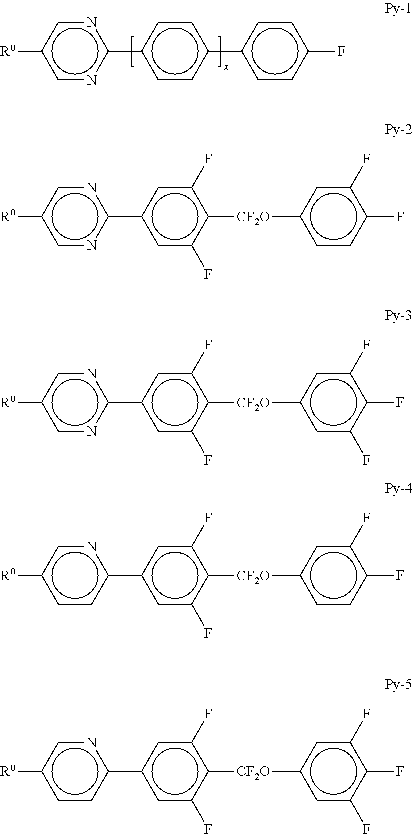

in which R⁰ is preferably straight-chain alkyl having 2-5 C atoms. x denotes 0 or 1, preferably x=1. Preferred mixtures comprise 3-30% by weight, in particular 5-20% by weight, of this (these) pyri(mi)dine compound(s).

It has been found that even a relatively small proportion of compounds of the formula I mixed with conventional liquid-crystal materials, but in particular with one or more compounds of the formulae II to XXVII, results in a considerable increase in the light stability and in low birefringence values, with broad nematic phases with low smectic-nematic transition temperatures being observed at the same time, improving the shelf life. At the same time, the mixtures exhibit very low threshold voltages and very good values of the VHR on exposure to UV.

The term “alkyl” or “alkyl*” in this application encompasses straight-chain and branched alkyl groups having 1-7 carbon atoms, in particular the straight-chain groups methyl, ethyl, propyl, butyl, pentyl, hexyl and heptyl. Groups having 1-6 carbon atoms are generally preferred.

The term “alkenyl” or “alkenyl*” in this application encompasses straight-chain and branched alkenyl groups having 2-7 carbon atoms, in particular the straight-chain groups. Preferred alkenyl groups are C₂-C₇-1E-alkenyl, C₄-C₇-1E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of particularly preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having up to 5 carbon atoms are generally preferred.

The term “fluoroalkyl” in this application encompasses straight-chain groups having at least one fluorine atom, preferably a terminal fluorine, i.e. fluoromethyl, 2-fluoroethyl, 3-fluoropropyl, 4-fluorobutyl, 5-fluoropentyl, 6-fluorohexyl and 7-fluoroheptyl. However, other positions of the fluorine are not excluded.

The term “oxaalkyl” or “alkoxy” in this application encompasses straight-chain radicals of the formula CₙH₂ₙ₊₁—O—(CH₂)ₘ, in which n and m each, independently of one another, denote 1 to 6. m may also denote 0. Preferably, n=1 and m=1-6 or m=0 and n=1-3.

Through a suitable choice of the meanings of R⁰ and X⁰, the addressing times, the threshold voltage, the steepness of the transmission characteristic lines, etc., can be modified in the desired manner. For example, 1E-alkenyl radicals, 3E-alkenyl radicals, 2E-alkenyloxy radicals and the like generally result in shorter addressing times, improved nematic tendencies and a higher ratio between the elastic constants k₃₃ (bend) and k₁₁ (splay) compared with alkyl and alkoxy radicals. 4-Alkenyl radicals, 3-alkenyl radicals and the like generally give lower threshold voltages and lower values of k₃₃/k₁₁ compared with alkyl and alkoxy radicals. The mixtures according to the invention are distinguished, in particular, by high k₁ values and thus have significantly faster response times than the mixtures from the prior art.

The optimum mixing ratio of the compounds of the above-mentioned formulae depends substantially on the desired properties, on the choice of the components of the above-mentioned formulae and on the choice of any further components that may be present.

Suitable mixing ratios within the range indicated above can easily be determined from case to case.

The total amount of compounds of the above-mentioned formulae in the mixtures according to the invention is not crucial. The mixtures can therefore comprise one or more further components for the purposes of optimisation of various properties. However, the observed effect on the desired improvement in the properties of the mixture is generally greater, the higher the total concentration of compounds of the above-mentioned formulae.

In a particularly preferred embodiment, the media according to the invention comprise compounds of the formulae IV to VIII in which X⁰ denotes F, OCF₃, OCHF₂, OCH═CF₂, OCF═CF₂ or OCF₂—CF₂H. A favourable synergistic action with the compounds of the formula I results in particularly advantageous properties. In particular, mixtures comprising compounds of the formulae I and VI, or I and XI, or I and VI and XI are distinguished by their low threshold voltage.

The individual compounds of the above-mentioned formulae and the sub-formulae thereof which can be used in the media according to the invention are either known or can be prepared analogously to the known compounds.

The invention also relates to electro-optical displays, such as, for example, TN, STN, TFT, OCB, IPS, FFS, positive VA, PS-TN, PS-IPS, PS-VA, PS-FFS or MLC displays, having two plane-parallel outer plates, which, together with a frame, form a cell, integrated non-linear elements for switching individual pixels on the outer plates, and a nematic liquid-crystal mixture having positive dielectric anisotropy and high specific resistance located in the cell, which contain media of this type, and to the use of these media for electro-optical purposes.

Furthermore, the mixtures according to the invention are also suitable for positive VA applications, also called HT-VA applications. These are taken to mean electro-optical displays having an in-plane addressing electrode configuration and homeotropic arrangement of the liquid-crystal medium having positive dielectric anisotropy.

The mixtures according to the invention are particularly preferred for TN-TFT display applications having a low operating voltage, i.e. particularly preferably for notebook applications.

The liquid-crystal mixtures according to the invention enable a significant broadening of the available parameter latitude. The achievable combinations of clearing point, viscosity at low temperature, thermal and UV stability and high optical anisotropy are far superior to previous materials from the prior art.

The mixtures according to the invention are particularly suitable for mobile applications and high Δn TFT applications, such as, for example, PDAs, notebooks, LCD-TVs and monitors.

The liquid-crystal mixtures according to the invention, while retaining the nematic phase down to −20° C. and preferably down to −30° C., particularly preferably down to −40° C., and the clearing point ≧70° C., preferably ≧75° C., at the same time allow rotational viscosities γ₁ of 120 mPa·s, particularly preferably ≦100 mPa·s, to be achieved, enabling excellent MLC displays having fast response times to be achieved.

The dielectric anisotropy Δ∈ of the liquid-crystal mixtures according to the invention is preferably ≧+8, particularly preferably ≧+12. In addition, the mixtures are characterised by low operating voltages. The threshold voltage of the liquid-crystal mixtures according to the invention is preferably ≦1.5 V, in particular 1.2 V.

The birefringence Δn of the liquid-crystal mixtures according to the invention is preferably ≧0.08, in particular ≧0.10 and very particularly preferably ≧0.11.

The nematic phase range of the liquid-crystal mixtures according to the invention preferably has a width of at least 90°, in particular at least 100°. This range preferably extends at least from −25° C. to +70° C.

If the mixtures according to the invention are used in FFS applications, the mixtures preferably have a value of the dielectric anisotropy of 3-12 and a value of the optical anisotropy of 0.07-0.13.

It goes without saying that, through a suitable choice of the components of the mixtures according to the invention, it is also possible for higher clearing points (for example above 100° C.) to be achieved at higher threshold voltages or lower clearing points to be achieved at lower threshold voltages with retention of the other advantageous properties. At viscosities correspondingly increased only slightly, it is likewise possible to obtain mixtures having a higher Δ∈ and thus low thresholds. The MLC displays according to the invention preferably operate at the first Gooch and Tarry transmission minimum [C. H. Gooch and H. A. Tarry, Electron. Lett. 10, 2-4, 1974; C. H. Gooch and H. A. Tarry, Appl. Phys., Vol. 8, 1575-1584, 1975], where, besides particularly favourable electro-optical properties, such as, for example, high steepness of the characteristic line and low angle dependence of the contrast (German patent 30 22 818), lower dielectric anisotropy is sufficient at the same threshold voltage as in an analogous display at the second minimum. This enables significantly higher specific resistance values to be achieved using the mixtures according to the invention at the first minimum than in the case of mixtures comprising cyano compounds. Through a suitable choice of the individual components and their proportions by weight, the person skilled in the art is able to set the birefringence necessary for a pre-specified layer thickness of the MLC display using simple routine methods.

The construction of the MLC display according to the invention from polarisers, electrode base plates and surface-treated electrodes corresponds to the usual design for displays of this type. The term usual design is broadly drawn here and also encompasses all derivatives and modifications of the MLC display, in particular including matrix display elements based on poly-Si TFTs or MIM.

A significant difference between the displays according to the invention and the hitherto conventional displays based on the twisted nematic cell consists, however, in the choice of the liquid-crystal parameters of the liquid-crystal layer.

The liquid-crystal mixtures which can be used in accordance with the invention are prepared in a manner conventional per se, for example by mixing one or more compounds of the formula I with one or more compounds of the formulae II-XXVII or with further liquid-crystalline compounds and/or additives. In general, the desired amount of the components used in lesser amount is dissolved in the components making up the principal constituent, advantageously at elevated temperature. It is also possible to mix solutions of the components in an organic solvent, for example in acetone, chloroform or methanol, and to remove the solvent again, for example by distillation, after thorough mixing.

The dielectrics may also comprise further additives known to the person skilled in the art and described in the literature, such as, for example, UV stabilisers, such as Tinuvin® from Ciba Chemicals, antioxidants, free-radical scavengers, nanoparticles, etc. For example, 0-15% of pleochroic dyes or chiral dopants can be added. Suitable stabilisers and dopants are mentioned below in Tables C and D.

Polymerisable compounds, so-called reactive mesogens (RMs), for example as disclosed in U.S. Pat. No. 6,861,107, may furthermore be added to the mixtures according to the invention in concentrations of preferably 0.12-5% by weight, particularly preferably 0.2-2% by weight, based on the mixture. These mixtures may optionally also comprise an initiator, as described, for example, in U.S. Pat. No. 6,781,665. The initiator, for example Irganox-1076 from Ciba, is preferably added to the mixture comprising polymerisable compounds in amounts of 0-1%. Mixtures of this type can be used for so-called polymer-stabilised VA (PS-VA) or PSA (polymer sustained VA) modes, in which polymerisation of the reactive mesogens is intended to take place in the liquid-crystalline mixture. The prerequisite for this is that the liquid-crystal mixture does not itself comprise any polymerisable components.

In a preferred embodiment of the invention, the polymerisable compounds are selected from the compounds of the formula M

R^{Ma}-A^{M1}-(Z^{M1}-A^{M2})ₘ₁-R^{Mb} M

in which the individual radicals have the following meanings:
R^{Ma} and R^{Mb} each, independently of one another, denote P, P-Sp-, H, halogen, SF₅, NO₂, an alkyl, alkenyl or alkynyl group, where at least one of the radicals R^{Ma} and R^{Mb} preferably denotes or contains a group P or P-Sp-,
P denotes a polymerisable group,
Sp denotes a spacer group or a single bond,
A^{M1} and A^{M2} each, independently of one another, denote an aromatic, heteroaromatic, alicyclic or heterocyclic group, preferably having 4 to 25 ring atoms, preferably C atoms, which may also include or contain fused rings, and which may optionally be mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-, preferably P, P-Sp-, H, OH, CH₂OH, halogen, SF₅, NO₂, an alkyl, alkenyl or alkynyl group,
Y¹ denotes halogen,
Z^{M1} denotes —O—, -5-, —CO—, —CO—O—, —COO—, —O—CO—O—, —OCH₂—, —CH₂O—, —SCH₂—, —CH₂S—, —CF₂O—, —OCF₂—, —CF₂S—, —SCF₂—, —(CH₂)ₙ₁—, —CF₂CH₂—, —CH₂CF₂—, —(CF₂)ₙ₁—, —CH═CH—, —CF═CF—, —C≡C—, —CH═CH—, —COO—, —OCO—CH═CH—, CR⁰R⁰⁰ or a single bond,
R⁰ and R⁰⁰ each, independently of one another, denote H or alkyl having 1 to 12 C atoms,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms,
m1 denotes 0, 1, 2, 3 or 4, and
n1 denotes 1, 2, 3 or 4,
   where at least one, preferably one, two or three, particularly preferably one or two, from the group R^{Ma}, R^{Mb} and the substitutents L present denotes a group P or P-Sp- or contains at least one group P or P-Sp-.

Particularly preferred compounds of the formula M are those in which
R^{Ma} and R^{Mb} each, independently of one another, denote P, P-Sp-, H, F, Cl, Br, I, —CN, —NO₂, —NCO, —NCS, —OCN, —SCN, SF₅ or straight-chain or branched alkyl having 1 to 25 C atoms, in which, in addition, one or more non-adjacent CH₂ groups may each be replaced, independently of one another, by —C(R⁰)═C(R⁰⁰)—, —C≡C—, —N(R⁰⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, Br, I, CN, P or P-Sp-, where at least one of the radicals R^{Ma} and R^{Mb} preferably denotes or contains a group P or P-Sp-,
A^{M1} and A^{M2} each, independently of one another, denote 1,4-phenylene, naphthalene-1,4-diyl, naphthalene-2,6-diyl, phenanthrene-2,7-diyl, anthracene-2,7-diyl, fluorene-2,7-diyl, coumarine, flavone, where, in addition, one or more CH groups in these groups may be replaced by N, cyclohexane-1,4-diyl, in which, in addition, one or more non-adjacent CH₂ groups may be replaced by O and/or S, 1,4-cyclohexenylene, bicyclo[1.1.1]pentane-1,3-diyl, bicyclo[2.2.2]octane-1,4-diyl, spiro[3.3]heptane-2,6-diyl, piperidine-1,4-diyl, decahydronaphthalene-2,6-diyl, 1,2,3,4-tetrahydronaphthalene-2,6-diyl, indane-2,5-diyl or octahydro-4,7-methanoindane-2,5-diyl, where all these groups may be unsubstituted or mono- or polysubstituted by L,
L denotes P, P-Sp-, OH, CH₂OH, F, Cl, Br, I, —CN, —NO₂, —NCO, —NCS, —OCN, —SCN, —C(═O)N(R^{x})₂, —C(═O)Y¹, —C(═O)R^{x}, —N(R^{x})₂, optionally substituted silyl, optionally substituted aryl having 6 to 20 C atoms, or straight-chain or branched alkyl, alkoxy, alkylcarbonyl, alkoxycarbonyl, alkylcarbonyloxy or alkoxycarbonyloxy having 1 to 25 C atoms, in which, in addition, one or more H atoms may be replaced by F, Cl, P or P-Sp-,
P denotes a polymerisable group,
Y¹ denotes halogen,
R^{x} denotes P, P-Sp-, H, halogen, straight-chain, branched or cyclic alkyl having 1 to 25 C atoms, in which, in addition, one or more non-adjacent CH₂ groups may be replaced by —O—, —S—, —CO—, —CO—O—, —O—CO—, —O—CO—O— in such a way that O and/or S atoms are not linked directly to one another, and in which, in addition, one or more H atoms may be replaced by F, Cl, P or P-Sp-, an optionally substituted aryl or aryloxy group having 6 to 40 C atoms, or an optionally substituted heteroaryl or heteroaryloxy group having 2 to 40 C atoms.

Very particular preference is given to compounds of the formula M in which one of R^{Ma} and R^{Mb} or both denote(s) P or P-Sp-.

Suitable and preferred polymerisable compounds for use in displays according to the invention are selected, for example, from the following formulae:

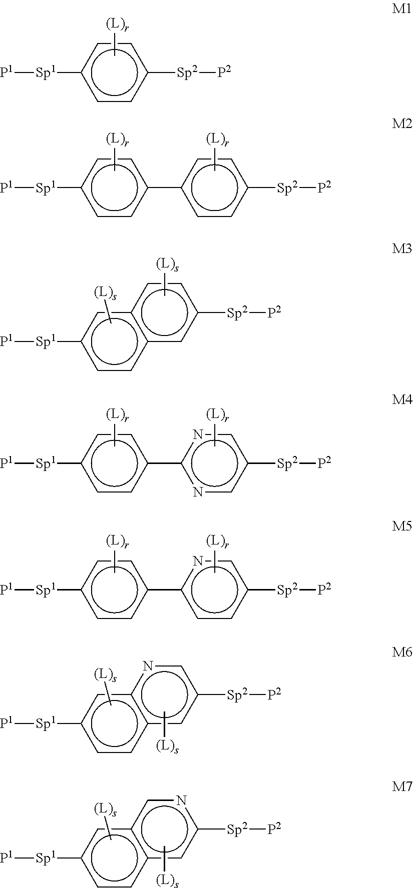

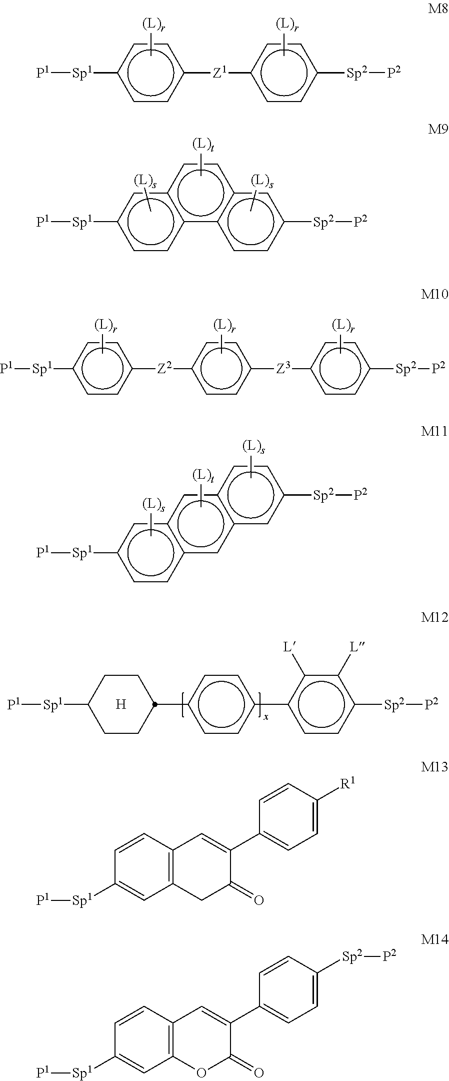

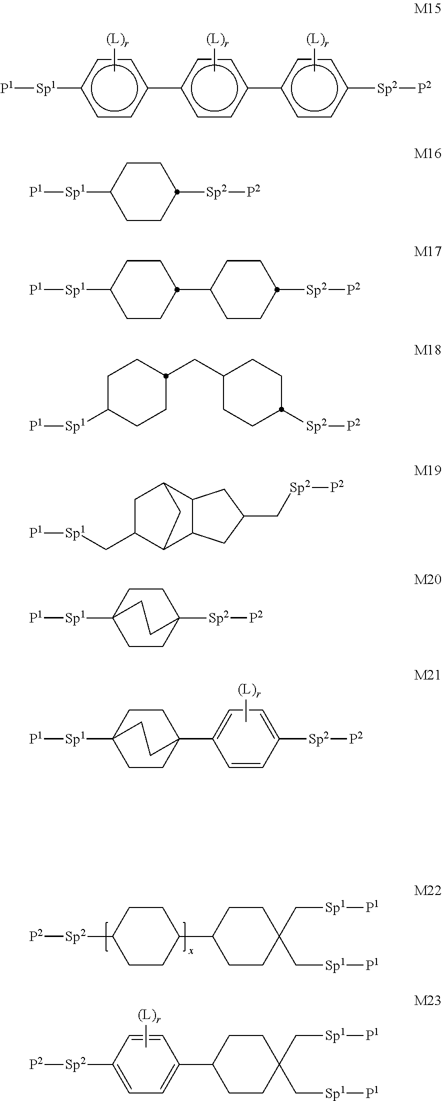

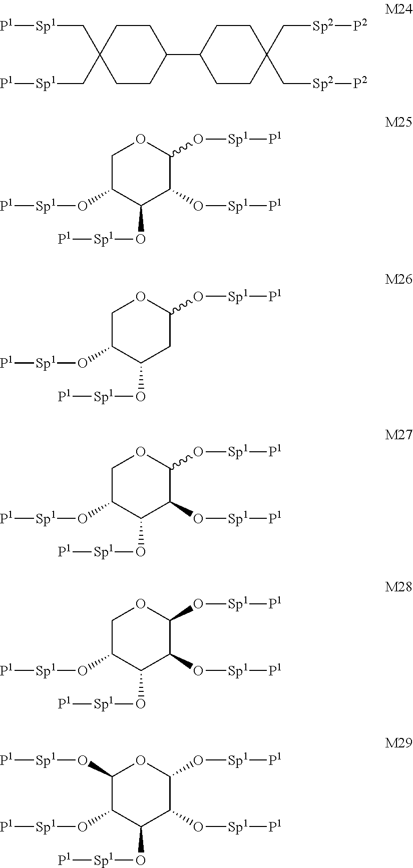

in which the individual radicals have the following meanings:
P¹ and P² each, independently of one another, denote a polymerisable group, preferably having one of the meanings indicated above and below for P, particularly preferably an acrylate, methacrylate, fluoroacrylate, oxetane, vinyloxy or epoxy group,
Sp¹ and Sp² each, independently of one another, denote a single bond or a spacer group, preferably having one of the meanings indicated above and below for Sp^{a}, and particularly preferably —(CH₂)ₚ₁—, —(CH₂)ₚ₁—O—, —(CH₂)ₚ₁—CO—O— or —(CH₂)ₚ₁—O—CO—O—, in which p1 is an integer from 1 to 12, and where the linking of the last-mentioned groups to the adjacent ring takes place via the O atom, where one or more of the radicals P¹-Sp¹- and P²-Sp²- may also denote a radical R^{aa}, with the proviso that at least one of the radicals P¹-Sp¹- and P²-Sp²- present does not denote R^{aa},
R^{aa} denotes H, F, Cl, CN or straight-chain or branched alkyl having 1 to 25 C atoms, in which, in addition, one or more non-adjacent CH₂ groups may each be replaced, independently of one another, by —C(R⁰)═C(R⁰⁰)—, —C≡C—, —N(R⁰)—, —O—, —S—, —CO—, —CO—O—, —O—CO—, —O—CO—O— in such a way that O and/or S atoms are not linked directly to one another, and in which, in addition, one or more H atoms may be replaced by F, Cl, CN or P¹-Sp¹-, particularly preferably straight-chain or branched, optionally mono- or polyfluorinated alkyl, alkoxy, alkenyl, alkynyl, alkylcarbonyl, alkoxycarbonyl or alkylcarbonyloxy having 1 to 12 C atoms (where the alkenyl and alkynyl radicals have at least two C atoms and the branched radicals have at least three C atoms),
R⁰, R⁰⁰ each, independently of one another and on each occurrence identically or differently, denote H or alkyl having 1 to 12 C atoms,
R^{y} and R^{z} each, independently of one another, denote H, F, CH₃ or CF₃,
Z¹ denotes —O—, —CO—, —C(R^{y}R^{z})— or —CF₂CF₂—,
Z² and Z³ each, independently of one another, denote —CO—O—, —O—CO—, —CH₂O—, —OCH₂—, —CF₂O—, —OCF₂— or —(CH₂)ₙ—, where n is 2, 3 or 4,
L on each occurrence, identically or differently, denotes F, Cl, CN, SCN, SF₅ or straight-chain or branched, optionally mono- or polyfluorinated alkyl, alkoxy, alkenyl, alkynyl, alkylcarbonyl, alkoxycarbonyl, alkylcarbonyloxy or alkoxycarbonyloxy having 1 to 12 C atoms, preferably F,
L′ and L″ each, independently of one another, denote H, F or Cl,
r denotes 0, 1, 2, 3 or 4,
s denotes 0, 1, 2 or 3,
t denotes 0, 1 or 2,
x denotes 0 or 1.

Suitable polymerisable compounds are listed, for example, in Table E.

The liquid-crystalline media in accordance with the present application preferably comprise in total 0.01 to 10%, preferably 0.2 to 4.0%, particularly preferably 0.2 to 2.0%, of polymerisable compounds.

Particular preference is given to the polymerisable compounds of the formula M.

In the present application and in the examples below, the structures of the liquid-crystal compounds are indicated by means of acronyms, the transformation into chemical formulae taking place in accordance with Table A. All radicals CₙH₂ₙ₊₁ and CₘH₂ₘ₊₁ are straight-chain alkyl radicals having n and m C atoms respectively; n, m and k are integers and preferably denote 0, 1, 2, 3, 4, 5, 6, 7, 8, 9, 10, 11 or 12. The coding in Table B is self-evident. In Table A, only the acronym for the parent structure is indicated. In individual cases, the acronym for the parent structure is followed, separated by a dash, by a code for the substituents R¹*, R²*, L¹* and L²*:

| Code for | | | | |
|---|---|---|---|---|
| R¹*, R²*, L¹*, L²*, L³* | R¹* | R²* | L¹* | L²* |
| nm | CₙH₂ₙ₊₁ | CₘH₂ₘ₊₁ | H | H |
| nOm | CₙH₂ₙ₊₁ | OCₘH₂ₘ₊₁ | H | H |
| nO.m | OCₙH₂ₙ₊₁ | CₘH₂ₘ₊₁ | H | H |
| n | CₙH₂ₙ₊₁ | CN | H | H |
| nN.F | CₙH₂ₙ₊₁ | CN | F | H |
| nN.F.F | CₙH₂ₙ₊₁ | CN | F | F |
| nF | CₙH₂ₙ₊₁ | F | H | H |
| nCl | CₙH₂ₙ₊₁ | Cl | H | H |
| nOF | OCₙH₂ₙ₊₁ | F | H | H |
| nF.F | CₙH₂ₙ₊₁ | F | F | H |
| nF.F.F | CₙH₂ₙ₊₁ | F | F | F |
| nOCF₃ | CₙH₂ₙ₊₁ | OCF₃ | H | H |
| nOCF₃.F | CₙH₂ₙ₊₁ | OCF₃ | F | H |
| n-Vm | CₙH₂ₙ₊₁ | —CH═CH—CₘH₂ₘ₊₁ | H | H |
| nV-Vm | CₙH₂ₙ₊₁—CH═CH— | —CH═CH—CₘH₂ₘ₊₁ | H | H |

Preferred mixture components are shown in Tables A and B.

TABLE A

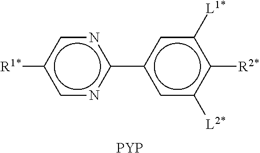

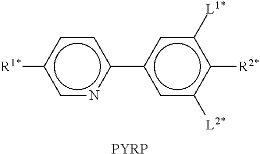

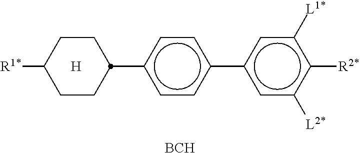

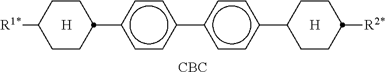

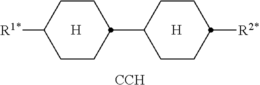

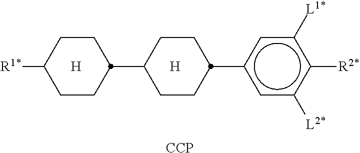

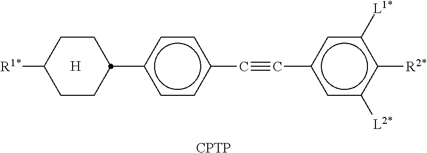

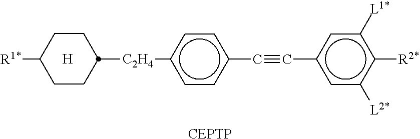

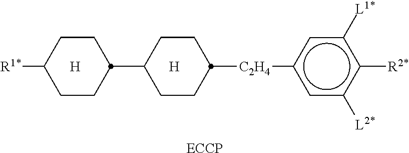

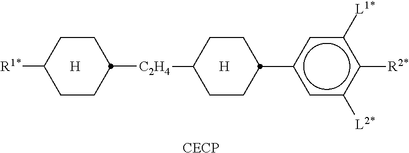

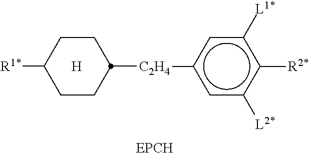

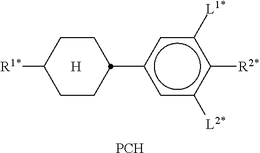

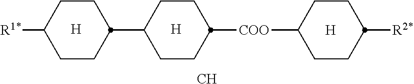

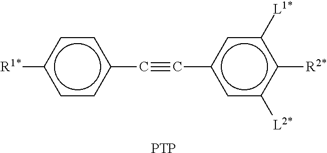

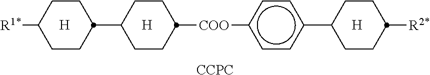

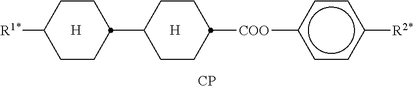

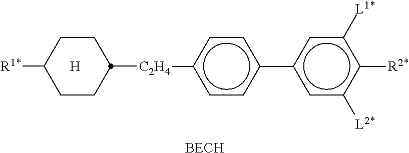

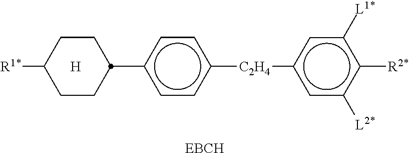

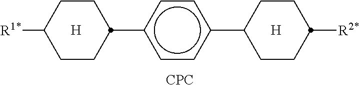

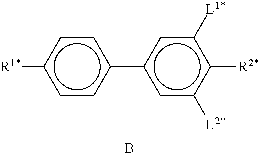

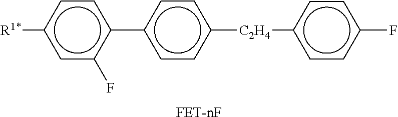

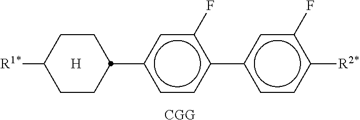

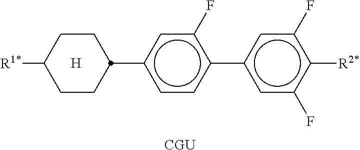

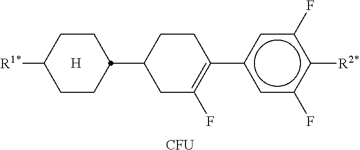

TABLE B

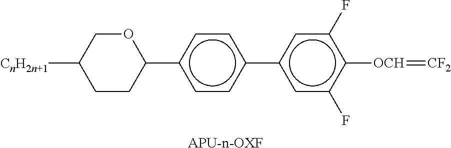

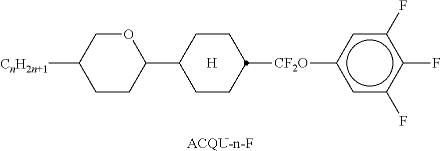

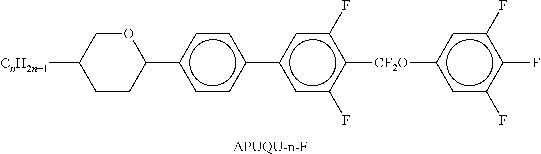

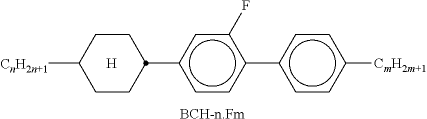

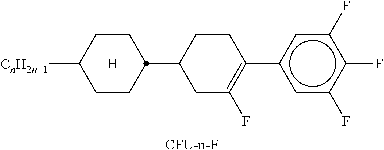

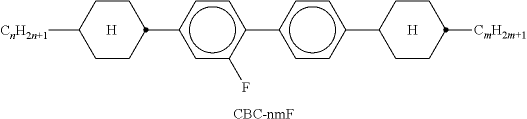

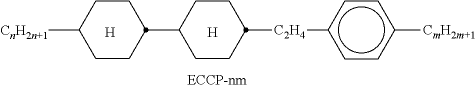

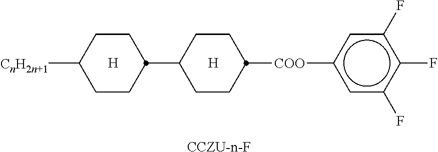

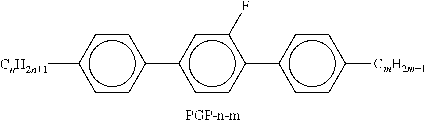

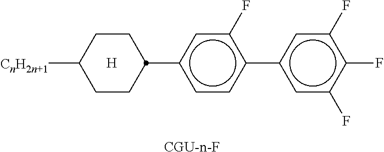

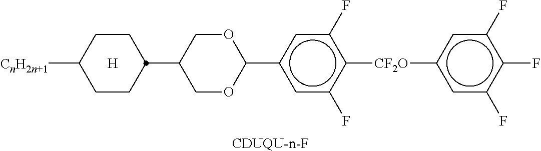

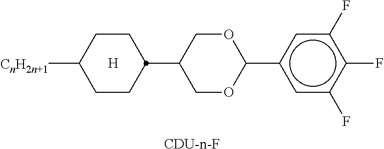

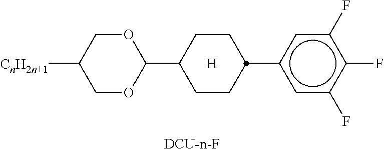

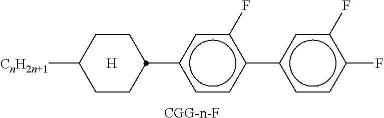

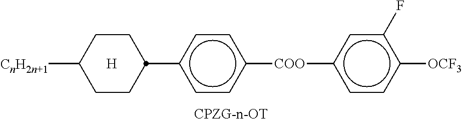

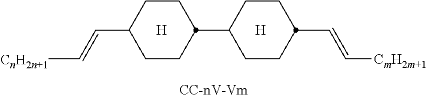

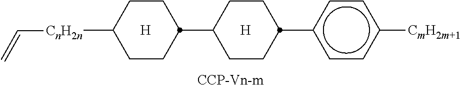

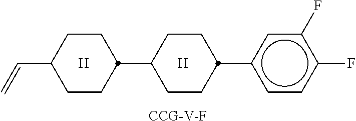

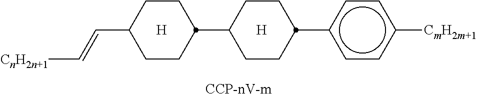

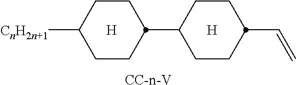

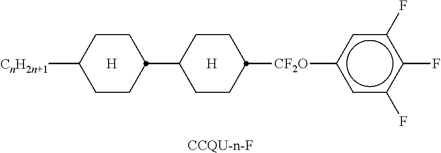

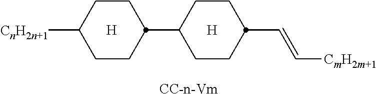

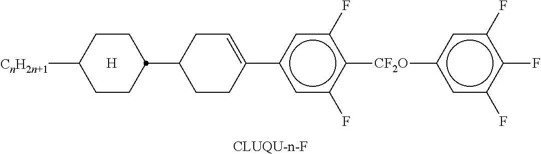

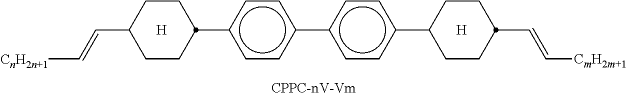

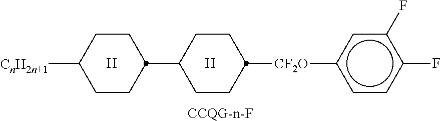

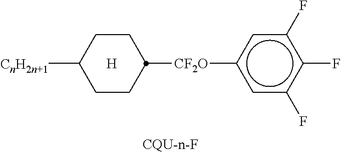

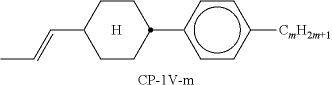

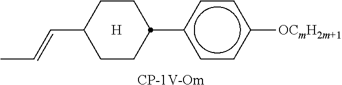

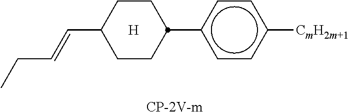

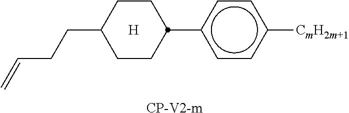

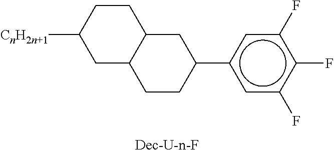

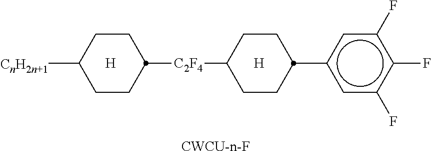

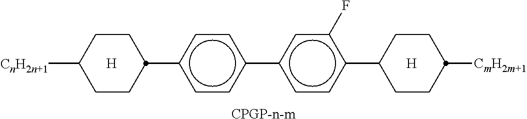

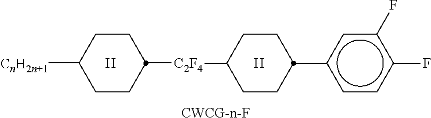

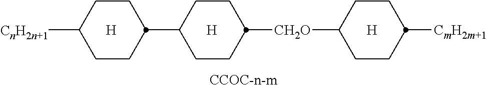

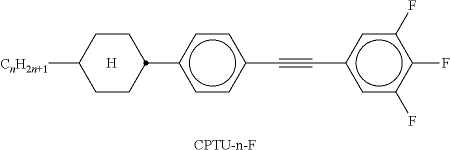

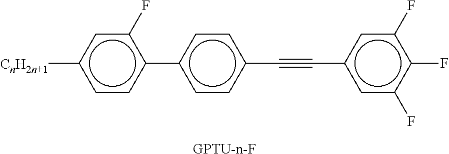

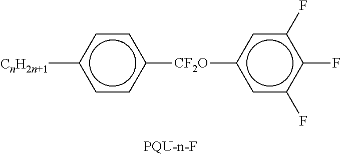

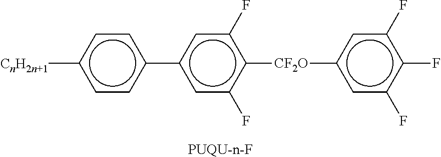

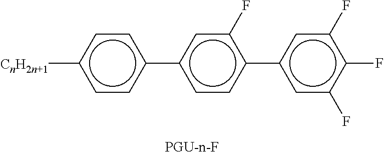

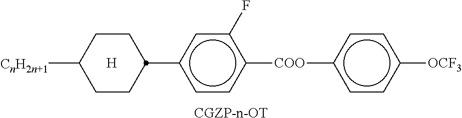

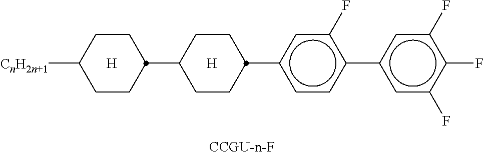

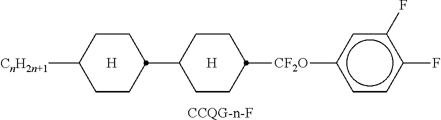

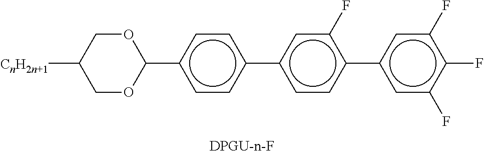

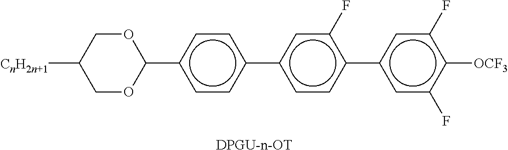

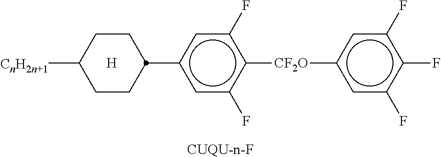

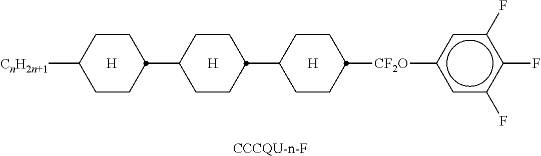

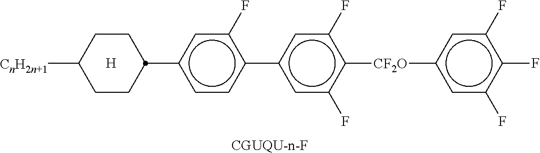

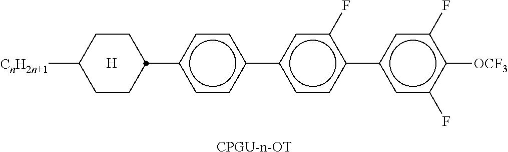

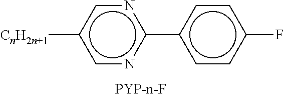

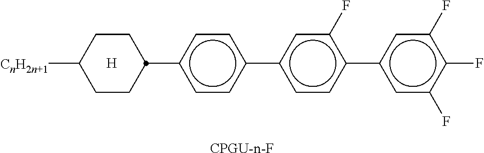

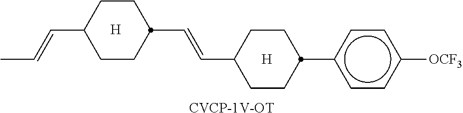

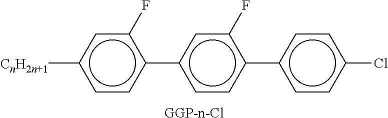

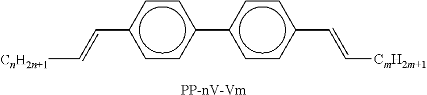

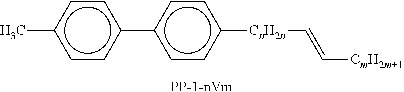

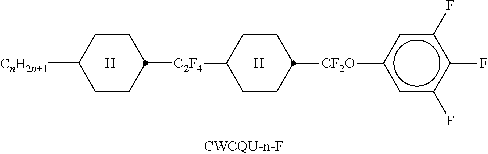

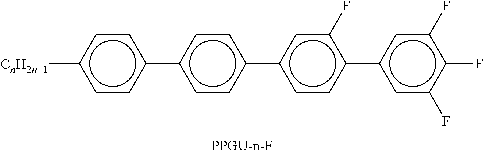

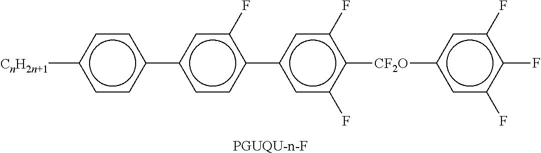

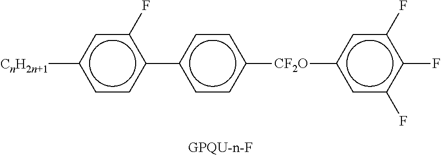

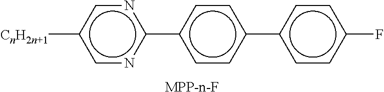

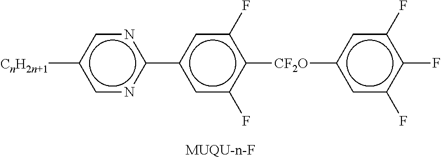

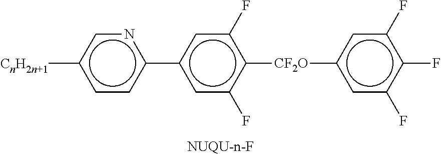

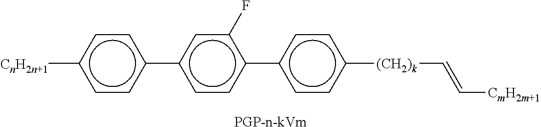

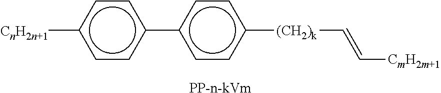

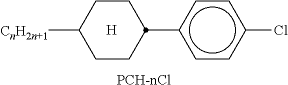

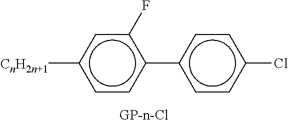

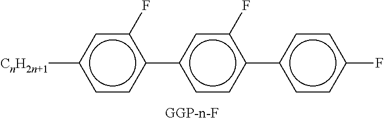

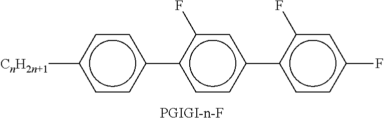

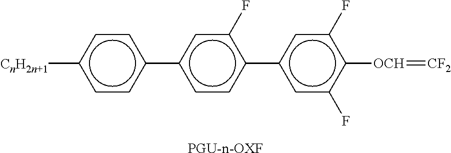

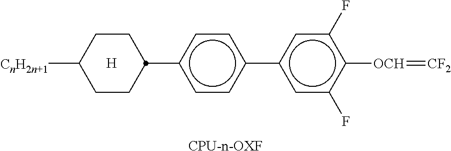

Particular preference is given to liquid-crystalline mixtures which, besides the compounds of the formula I, comprise at least one, two, three, four or more compounds from Table B.

TABLE C
Table C indicates possible dopants which are generally added to the mixtures according to the invention.
The mixtures preferably comprise 0-10% by weight, in particular 0.01-5% by weight and particularly
preferably 0.01-3% by weight of dopants.

| | |
|---|---|
| 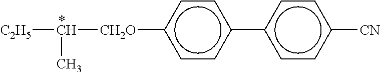 | C 15 |
| 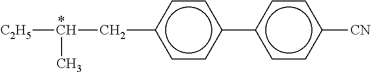 | CB 15 |
| 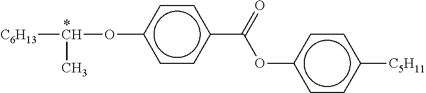 | CM 21 |
| 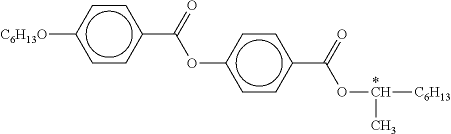 | R/S-811 |
| 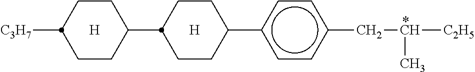 | CM 44 |
| 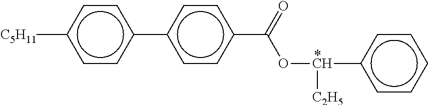 | CM 45 |
| 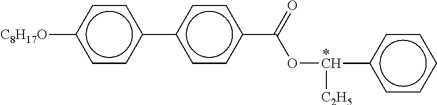 | CM 47 |
| 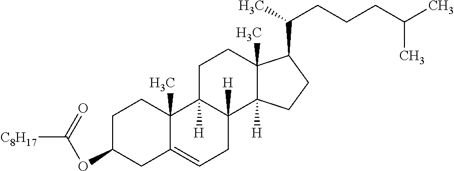 | CN |
| 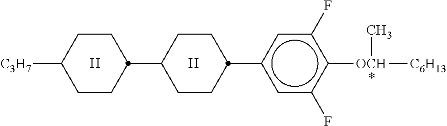 | R/S-2011 |
| 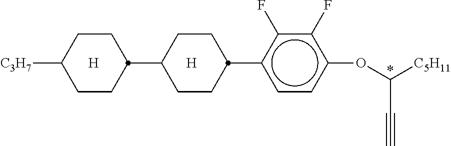 | R/S-3011 |
| 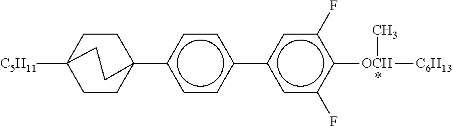 | R/S-4011 |
| 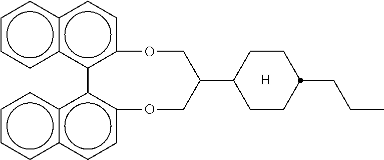 | R/S-5011 |
| 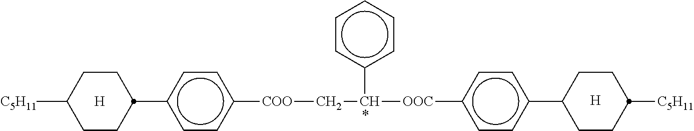 | R/S-1011 |

TABLE D
Stabilisers, which can be added, for example, to the mixtures according to the
invention in amounts of 0-10% by weight, are mentioned below.

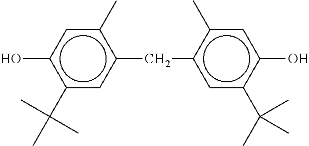

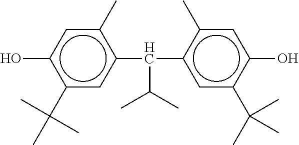

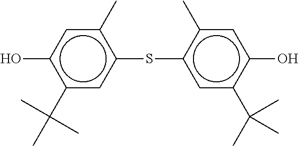

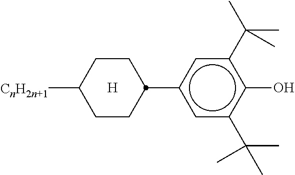

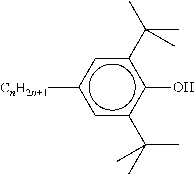

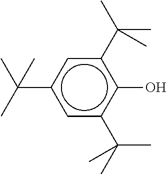

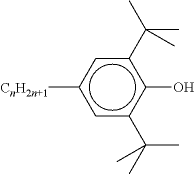

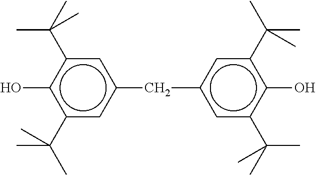

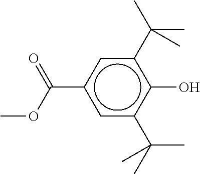

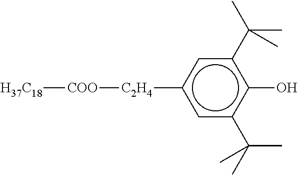

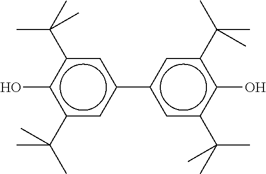

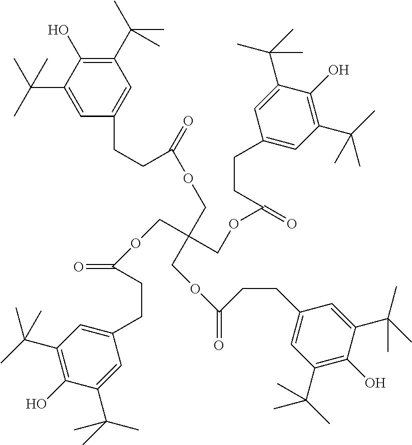 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

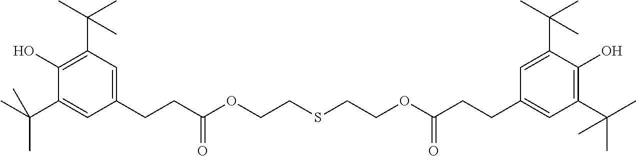 [SMILES: CC(C)(C)c1cc(CCC(=O)OCCSCCOC(=O)CCc2cc(C(C)(C)C)c(O)c(C(C)(C)C)c2)cc(C(C)(C)C)c1O]

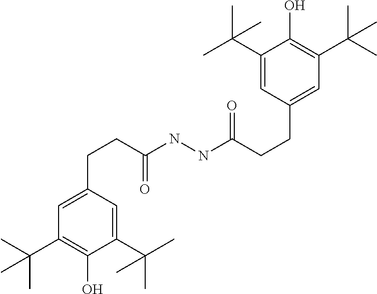 [SMILES: CC(C)(C)c1cc(CCC(=O)NNC(=O)CCc2cc(C(C)(C)C)c(O)c(C(C)(C)C)c2)cc(C(C)(C)C)c1O]

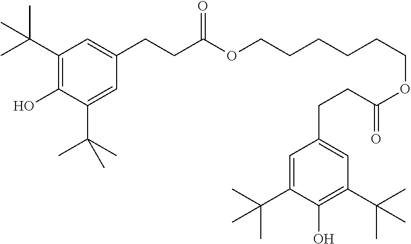 [SMILES: CC(C)(C)c1cc(CCC(=O)OCCCCCCOC(=O)CCc2cc(C(C)(C)C)c(O)c(C(C)(C)C)c2)cc(C(C)(C)C)c1O]

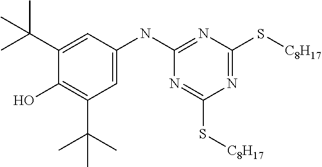

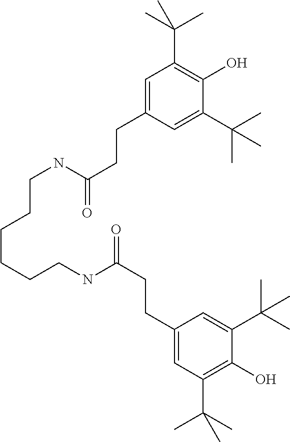 [SMILES: CC(C)(C)c1cc(CCC(=O)NCCCCCCNC(=O)CCc2cc(C(C)(C)C)c(O)c(C(C)(C)C)c2)cc(C(C)(C)C)c1O]

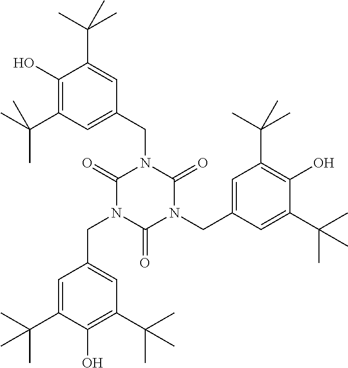 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

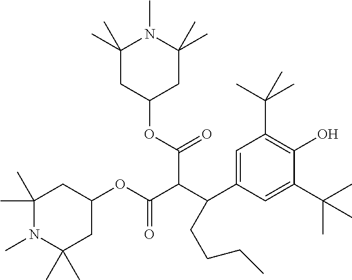 [SMILES: CCCCC(c1cc(C(C)(C)C)c(O)c(C(C)(C)C)c1)C(C(=O)OC1CC(C)(C)N(C)C(C)(C)C1)C(=O)OC1CC(C)(C)N(C)C(C)(C)C1]

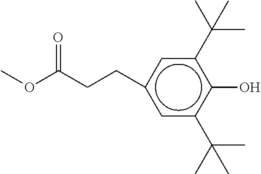

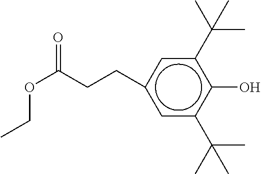

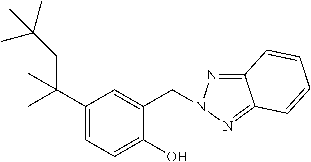 [SMILES: CC(C)(C)CC(C)(C)c1ccc(O)c(Cn2nc3ccccc3n2)c1]

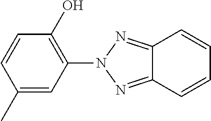 [SMILES: Cc1ccc(O)c(-n2nc3ccccc3n2)c1]

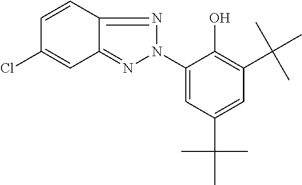 [SMILES: CC(C)(C)c1cc(-n2nc3ccc(Cl)cc3n2)c(O)c(C(C)(C)C)c1]

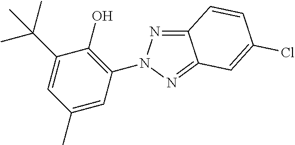 [SMILES: Cc1cc(-n2nc3ccc(Cl)cc3n2)c(O)c(C(C)(C)C)c1]

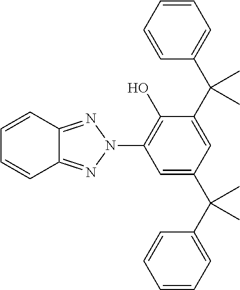 [SMILES: CC(C)(c1ccccc1)c1cc(-n2nc3ccccc3n2)c(O)c(C(C)(C)c2ccccc2)c1]

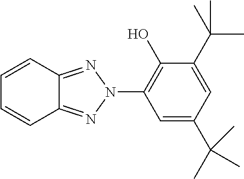 [SMILES: CC(C)(C)c1cc(-n2nc3ccccc3n2)c(O)c(C(C)(C)C)c1]

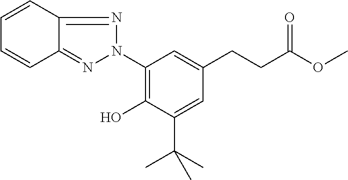 [SMILES: COC(=O)CCc1cc(-n2nc3ccccc3n2)c(O)c(C(C)(C)C)c1]

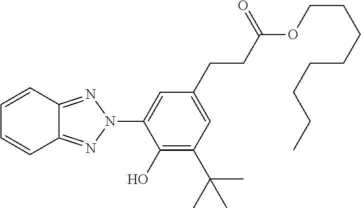 [SMILES: CCCCCCCCOC(=O)CCc1cc(-n2nc3ccccc3n2)c(O)c(C(C)(C)C)c1]

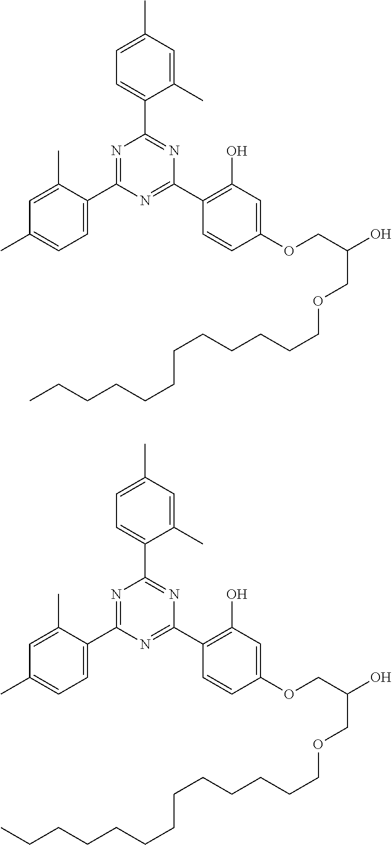

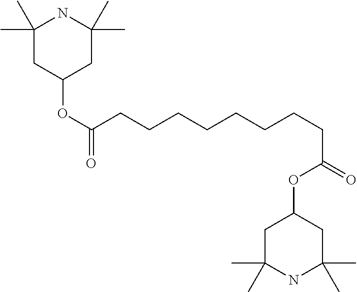

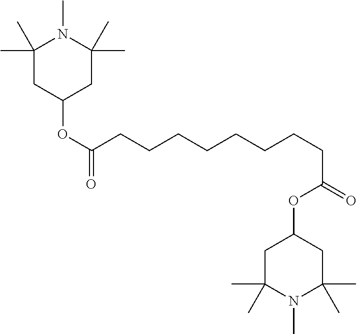

n = 1, 2, 3, 4, 5, 6 or 7

TABLE E
Polymerisable compounds (reactive mesogenic compounds), which can be added, for example, to the mixtures according
to the invention in amounts of 0.01-5% by weight, are mentioned below. It may also be necessary to add an
initiator for the polymerisation in amounts of 0-1% by weight.

| | |
|---|---|
| 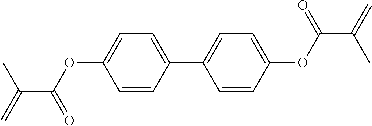 [SMILES: C=C(C)C(=O)Oc1ccc(-c2ccc(OC(=O)C(=C)C)cc2)cc1] | RM-1 |
| 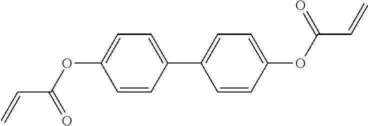 [SMILES: C=CC(=O)Oc1ccc(-c2ccc(OC(=O)C=C)cc2)cc1] | RM-2 |
| 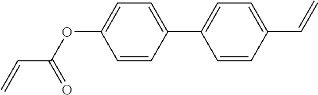 [SMILES: C=CC(=O)Oc1ccc(-c2ccc(C=C)cc2)cc1] | RM-3 |
| 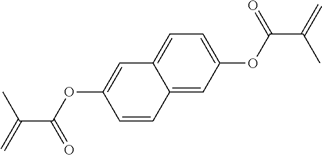 [SMILES: C=C(C)C(=O)Oc1ccc2cc(OC(=O)C(=C)C)ccc2c1] | RM-4 |
| 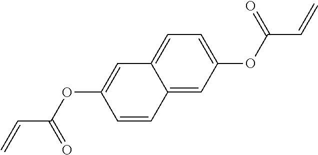 [SMILES: C=CC(=O)Oc1ccc2cc(OC(=O)C=C)ccc2c1] | RM-5 |
| 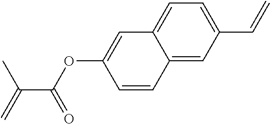 [SMILES: C=Cc1ccc2cc(OC(=O)C(=C)C)ccc2c1] | RM-6 |
| 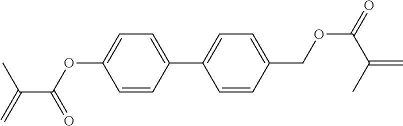 [SMILES: C=C(C)C(=O)OCc1ccc(-c2ccc(OC(=O)C(=C)C)cc2)cc1] | RM-7 |
| 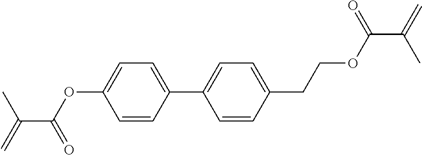 [SMILES: C=C(C)C(=O)OCCc1ccc(-c2ccc(OC(=O)C(=C)C)cc2)cc1] | RM-8 |
| 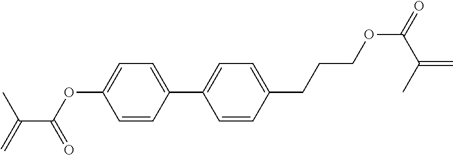 [SMILES: C=C(C)C(=O)OCCCc1ccc(-c2ccc(OC(=O)C(=C)C)cc2)cc1] | RM-9 |
| 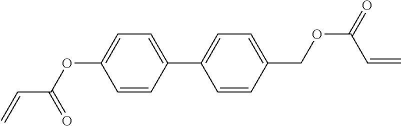 [SMILES: C=CC(=O)OCc1ccc(-c2ccc(OC(=O)C=C)cc2)cc1] | RM-10 |
| 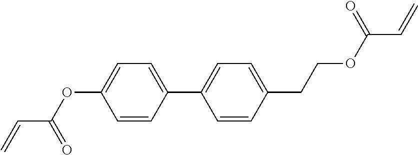 [SMILES: C=CC(=O)OCCc1ccc(-c2ccc(OC(=O)C=C)cc2)cc1] | RM-11 |
| 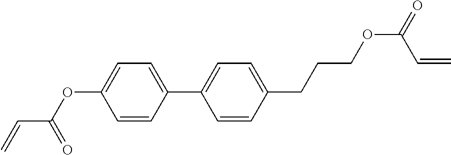 [SMILES: C=CC(=O)OCCCc1ccc(-c2ccc(OC(=O)C=C)cc2)cc1] | RM-12 |
| 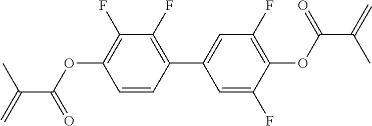 [SMILES: C=C(C)C(=O)Oc1ccc(-c2cc(F)c(OC(=O)C(=C)C)c(F)c2)c(F)c1F] | RM-13 |
| 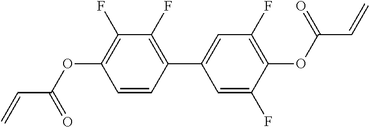 [SMILES: C=CC(=O)Oc1ccc(-c2cc(F)c(OC(=O)C=C)c(F)c2)c(F)c1F] | RM-14 |
| 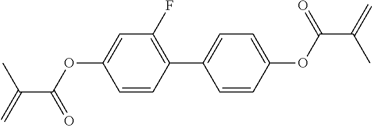 [SMILES: C=C(C)C(=O)Oc1ccc(-c2ccc(OC(=O)C(=C)C)cc2F)cc1] | RM-15 |
| 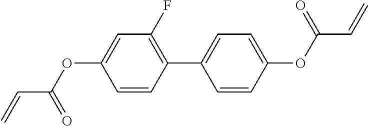 [SMILES: C=CC(=O)Oc1ccc(-c2ccc(OC(=O)C=C)cc2F)cc1] | RM-16 |
| 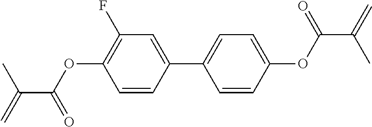 [SMILES: C=C(C)C(=O)Oc1ccc(-c2ccc(OC(=O)C(=C)C)c(F)c2)cc1] | RM-17 |
| 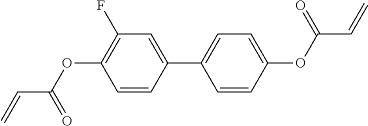 [SMILES: C=CC(=O)Oc1ccc(-c2ccc(OC(=O)C=C)c(F)c2)cc1] | RM-18 |
| 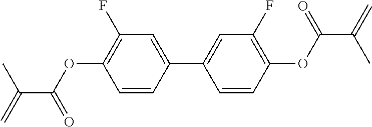 [SMILES: C=C(C)C(=O)Oc1ccc(-c2ccc(OC(=O)C(=C)C)c(F)c2)cc1F] | RM-19 |
| 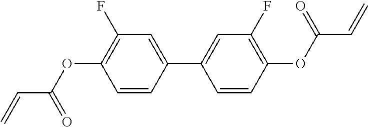 [SMILES: C=CC(=O)Oc1ccc(-c2ccc(OC(=O)C=C)c(F)c2)cc1F] | RM-20 |
| 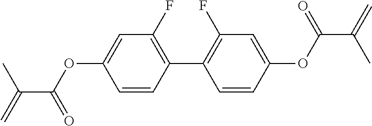 [SMILES: C=C(C)C(=O)Oc1ccc(-c2ccc(OC(=O)C(=C)C)cc2F)c(F)c1] | RM-21 |
| 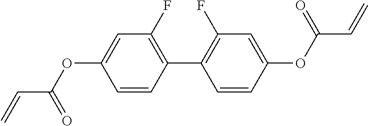 [SMILES: C=CC(=O)Oc1ccc(-c2ccc(OC(=O)C=C)cc2F)c(F)c1] | RM-22 |
| 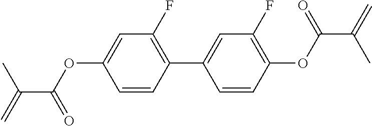 [SMILES: C=C(C)C(=O)Oc1ccc(-c2ccc(OC(=O)C(=C)C)c(F)c2)c(F)c1] | RM-23 |
| 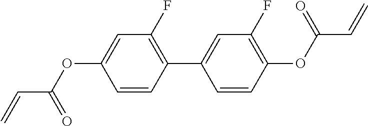 [SMILES: C=CC(=O)Oc1ccc(-c2ccc(OC(=O)C=C)c(F)c2)c(F)c1] | RM-24 |
| 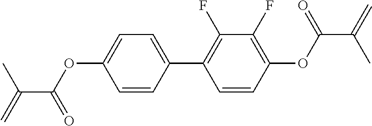 [SMILES: C=C(C)C(=O)Oc1ccc(-c2ccc(OC(=O)C(=C)C)c(F)c2F)cc1] | RM-25 |
| 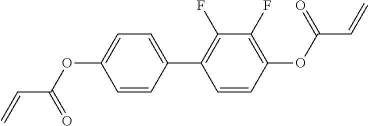 [SMILES: C=CC(=O)Oc1ccc(-c2ccc(OC(=O)C=C)c(F)c2F)cc1] | RM-26 |
| 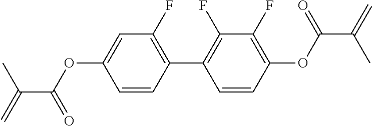 [SMILES: C=C(C)C(=O)Oc1ccc(-c2ccc(OC(=O)C(=C)C)c(F)c2F)c(F)c1] | RM-27 |
| 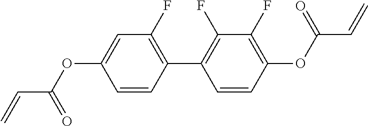 [SMILES: C=CC(=O)Oc1ccc(-c2ccc(OC(=O)C=C)c(F)c2F)c(F)c1] | RM-28 |
| 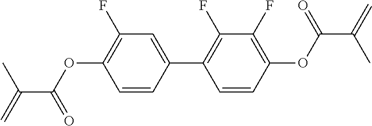 [SMILES: C=C(C)C(=O)Oc1ccc(-c2ccc(OC(=O)C(=C)C)c(F)c2F)cc1F] | RM-29 |
| 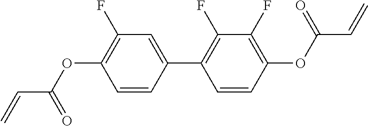 [SMILES: C=CC(=O)Oc1ccc(-c2ccc(OC(=O)C=C)c(F)c2F)cc1F] | RM-30 |
| 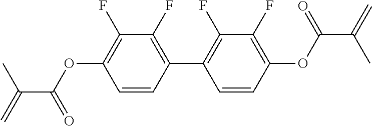 [SMILES: C=C(C)C(=O)Oc1ccc(-c2ccc(OC(=O)C(=C)C)c(F)c2F)c(F)c1F] | RM-31 |
| 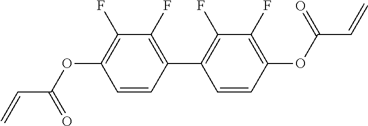 [SMILES: C=CC(=O)Oc1ccc(-c2ccc(OC(=O)C=C)c(F)c2F)c(F)c1F] | RM-32 |
| 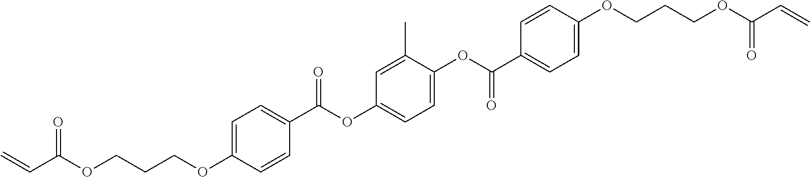 [SMILES: C=CC(=O)OCCCOc1ccc(C(=O)Oc2ccc(OC(=O)c3ccc(OCCCOC(=O)C=C)cc3)c(C)c2)cc1] | RM-33 |
| 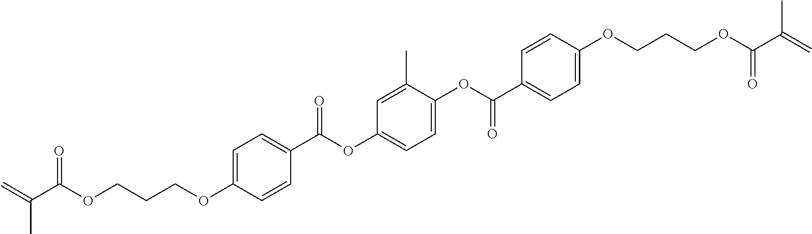 [SMILES: C=C(C)C(=O)OCCCOc1ccc(C(=O)Oc2ccc(OC(=O)c3ccc(OCCCOC(=O)C(=C)C)cc3)c(C)c2)cc1] | RM-34 |
| 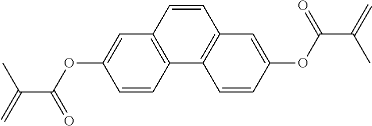 [SMILES: C=C(C)C(=O)Oc1ccc2c(ccc3cc(OC(=O)C(=C)C)ccc32)c1] | RM-35 |
| 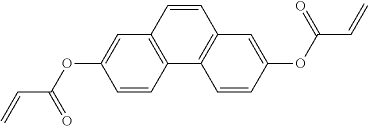 [SMILES: C=CC(=O)Oc1ccc2c(ccc3cc(OC(=O)C=C)ccc32)c1] | RM-36 |
| 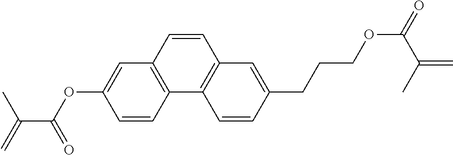 [SMILES: C=C(C)C(=O)OCCCc1ccc2c(ccc3cc(OC(=O)C(=C)C)ccc32)c1] | RM-37 |
| 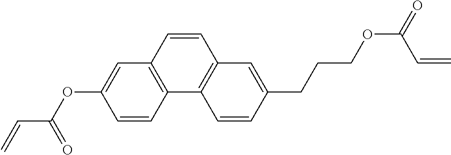 [SMILES: C=CC(=O)OCCCc1ccc2c(ccc3cc(OC(=O)C=C)ccc32)c1] | RM-38 |
| 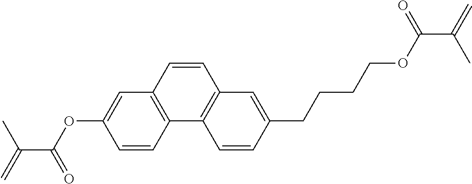 [SMILES: C=C(C)C(=O)OCCCCc1ccc2c(ccc3cc(OC(=O)C(=C)C)ccc32)c1] | RM-39 |
| 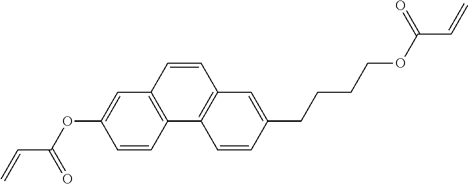 [SMILES: C=CC(=O)OCCCCc1ccc2c(ccc3cc(OC(=O)C=C)ccc32)c1] | RM-40 |
| 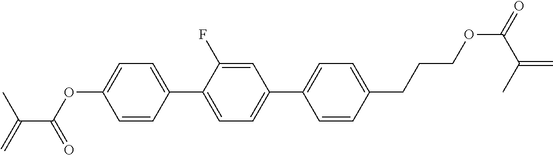 [SMILES: C=C(C)C(=O)OCCCc1ccc(-c2ccc(-c3ccc(OC(=O)C(=C)C)cc3)c(F)c2)cc1] | RM-41 |
| 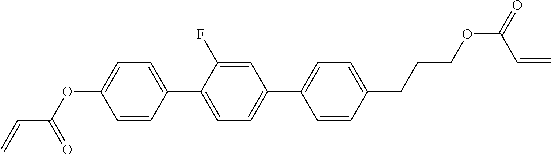 [SMILES: C=CC(=O)OCCCc1ccc(-c2ccc(-c3ccc(OC(=O)C=C)cc3)c(F)c2)cc1] | RM-42 |
| 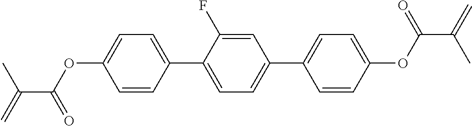 [SMILES: C=C(C)C(=O)Oc1ccc(-c2ccc(-c3ccc(OC(=O)C(=C)C)cc3)c(F)c2)cc1] | RM-43 |
| 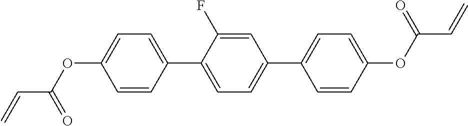 [SMILES: C=CC(=O)Oc1ccc(-c2ccc(-c3ccc(OC(=O)C=C)cc3)c(F)c2)cc1] | RM-44 |
| 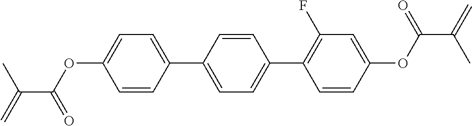 [SMILES: C=C(C)C(=O)Oc1ccc(-c2ccc(-c3ccc(OC(=O)C(=C)C)cc3F)cc2)cc1] | RM-45 |
| 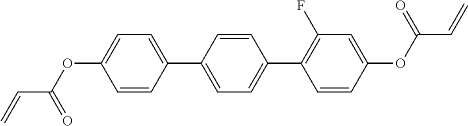 [SMILES: C=CC(=O)Oc1ccc(-c2ccc(-c3ccc(OC(=O)C=C)cc3F)cc2)cc1] | RM-46 |
| 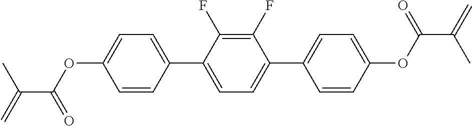 [SMILES: C=C(C)C(=O)Oc1ccc(-c2ccc(-c3ccc(OC(=O)C(=C)C)cc3)c(F)c2F)cc1] | RM-47 |
| 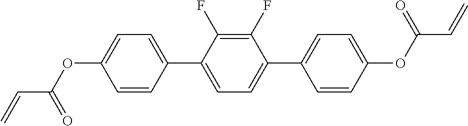 [SMILES: C=CC(=O)Oc1ccc(-c2ccc(-c3ccc(OC(=O)C=C)cc3)c(F)c2F)cc1] | RM-48 |
| 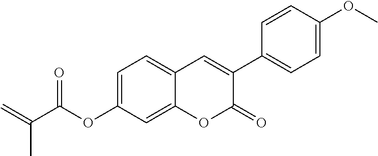 [SMILES: C=C(C)C(=O)Oc1ccc2cc(-c3ccc(OC)cc3)c(=O)oc2c1] | RM-49 |
| 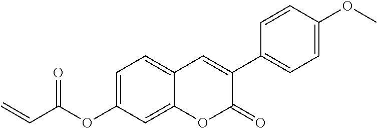 [SMILES: C=CC(=O)Oc1ccc2cc(-c3ccc(OC)cc3)c(=O)oc2c1] | RM-50 |
| 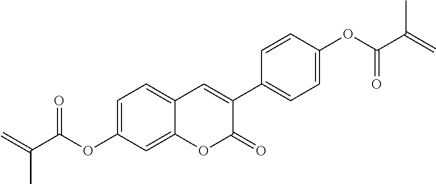 [SMILES: C=C(C)C(=O)Oc1ccc(-c2cc3ccc(OC(=O)C(=C)C)cc3oc2=O)cc1] | RM-51 |
| 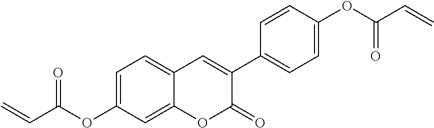 [SMILES: C=CC(=O)Oc1ccc(-c2cc3ccc(OC(=O)C=C)cc3oc2=O)cc1] | RM-52 |
| 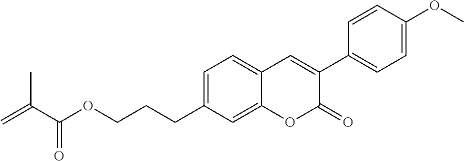 [SMILES: C=C(C)C(=O)OCCCc1ccc2cc(-c3ccc(OC)cc3)c(=O)oc2c1] | RM-53 |
| 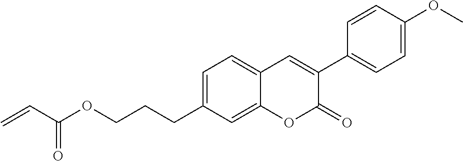 [SMILES: C=CC(=O)OCCCc1ccc2cc(-c3ccc(OC)cc3)c(=O)oc2c1] | RM-54 |
| 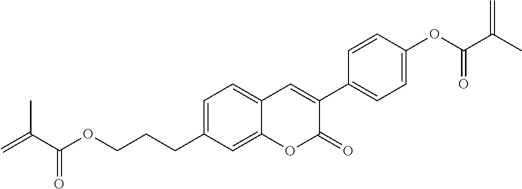 [SMILES: C=C(C)C(=O)OCCCc1ccc2cc(-c3ccc(OC(=O)C(=C)C)cc3)c(=O)oc2c1] | RM-55 |
| 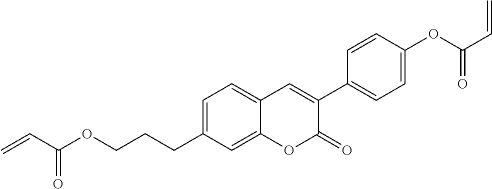 [SMILES: C=CC(=O)OCCCc1ccc2cc(-c3ccc(OC(=O)C=C)cc3)c(=O)oc2c1] | RM-56 |
| 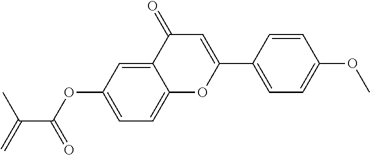 [SMILES: C=C(C)C(=O)Oc1ccc2oc(-c3ccc(OC)cc3)cc(=O)c2c1] | RM-57 |
| 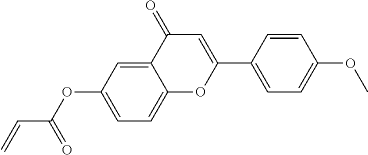 [SMILES: C=CC(=O)Oc1ccc2oc(-c3ccc(OC)cc3)cc(=O)c2c1] | RM-58 |
| 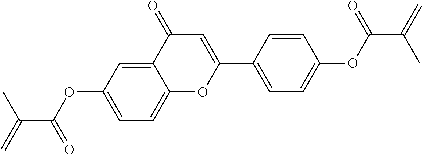 [SMILES: C=C(C)C(=O)Oc1ccc(-c2cc(=O)c3cc(OC(=O)C(=C)C)ccc3o2)cc1] | RM-59 |
| 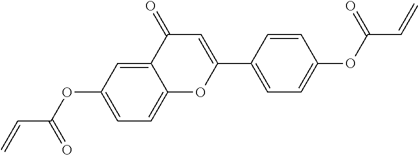 [SMILES: C=CC(=O)Oc1ccc(-c2cc(=O)c3cc(OC(=O)C=C)ccc3o2)cc1] | RM-60 |
| 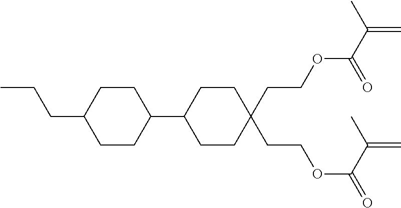 [SMILES: C=C(C)C(=O)OCCC1(CCOC(=O)C(=C)C)CCC(C2CCC(CCC)CC2)CC1] | RM-61 |
| 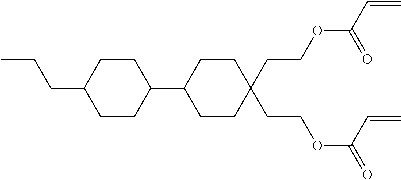 [SMILES: C=CC(=O)OCCC1(CCOC(=O)C=C)CCC(C2CCC(CCC)CC2)CC1] | RM-62 |
| 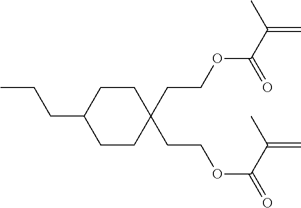 [SMILES: C=C(C)C(=O)OCCC1(CCOC(=O)C(=C)C)CCC(CCC)CC1] | RM-63 |
| 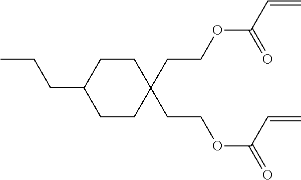 [SMILES: C=CC(=O)OCCC1(CCOC(=O)C=C)CCC(CCC)CC1] | RM-64 |
| 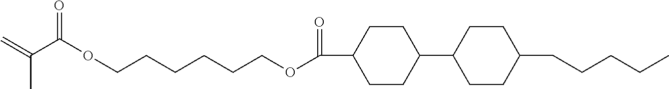 [SMILES: C=C(C)C(=O)OCCCCCCOC(=O)C1CCC(C2CCC(CCCCC)CC2)CC1] | RM-65 |
| 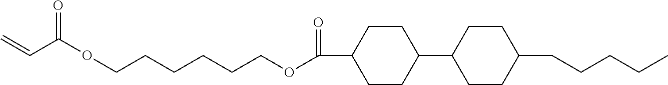 [SMILES: C=CC(=O)OCCCCCCOC(=O)C1CCC(C2CCC(CCCCC)CC2)CC1] | RM-66 |
| 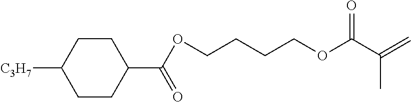 | RM-67 |
| 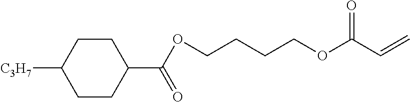 | RM-68 |
| 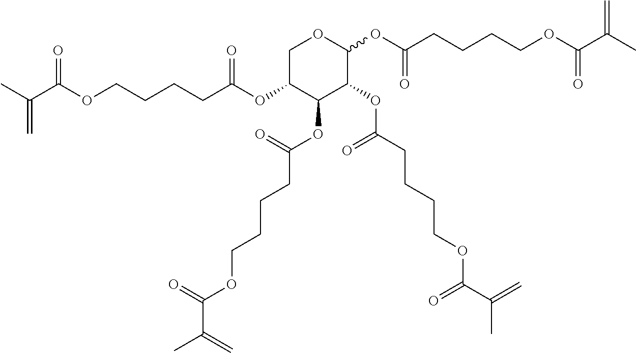 [SMILES: C=C(C)C(=O)OCCCCC(=O)OC1OC[C@@H](OC(=O)CCCCOC(=O)C(=C)C)[C@H](OC(=O)CCCCOC(=O)C(=C)C)[C@H]1OC(=O)CCCCOC(=O)C(=C)C] | RM-69 |
| 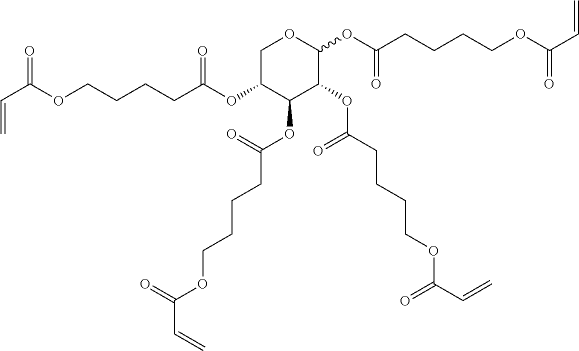 [SMILES: C=CC(=O)OCCCCC(=O)OC1OC[C@@H](OC(=O)CCCCOC(=O)C=C)[C@H](OC(=O)CCCCOC(=O)C=C)[C@H]1OC(=O)CCCCOC(=O)C=C] | RM-70 |
| 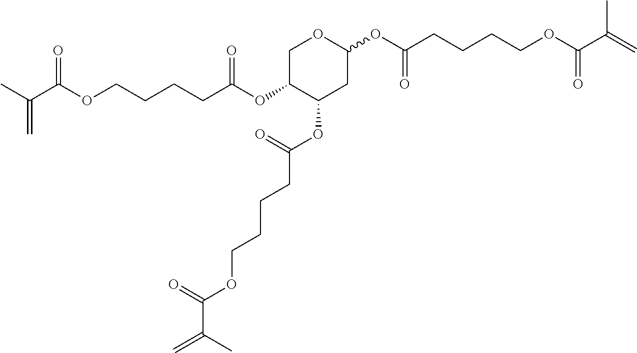 [SMILES: C=C(C)C(=O)OCCCCC(=O)OC1C[C@H](OC(=O)CCCCOC(=O)C(=C)C)[C@H](OC(=O)CCCCOC(=O)C(=C)C)CO1] | RM-71 |
| 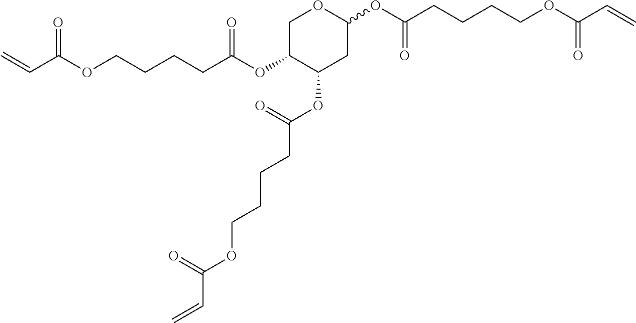 [SMILES: C=CC(=O)OCCCCC(=O)OC1C[C@H](OC(=O)CCCCOC(=O)C=C)[C@H](OC(=O)CCCCOC(=O)C=C)CO1] | RM-72 |
| 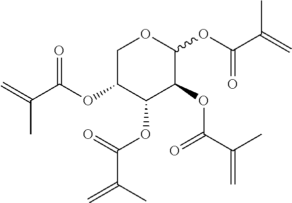 [SMILES: C=C(C)C(=O)OC1OC[C@@H](OC(=O)C(=C)C)[C@@H](OC(=O)C(=C)C)[C@@H]1OC(=O)C(=C)C] | RM-73 |
| 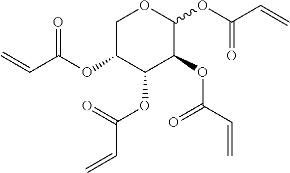 [SMILES: C=CC(=O)OC1OC[C@@H](OC(=O)C=C)[C@@H](OC(=O)C=C)[C@@H]1OC(=O)C=C] | RM-74 |

In a preferred embodiment of the present invention, the media according to the invention comprise one or more compounds selected from the group of the compounds from Table E. Mixtures of this type are particularly suitable, for example, for PS (polymer stabilised)-TN-, PS-IPS- or PS-FFS applications.

The following mixture examples are intended to explain the invention without limiting it.

Above and below, percentage data denote percent by weight. All temperatures are indicated in degrees Celsius. m.p. denotes melting point, cl.p.=clearing point. Furthermore, C=crystalline state, N=nematic phase, S=smectic phase and I=isotropic phase. The data between these symbols represent the transition temperatures. Furthermore,
Δn denotes the optical anisotropy at 589 nm and 20° C.,
γ₁ denotes the rotational viscosity (mPa·s) at 20° C.,
V₁₀ denotes the voltage (V) for 10% transmission (viewing angle perpendicular to the plate surface), (threshold voltage),
Δ∈ denotes the dielectric anisotropy at 20° C. and 1 kHz (Δ∈=∈_{∥}−∈_{⊥}, where ∈_{∥} denotes the dielectric constant parallel to the longitudinal axes of the molecules and ∈_{⊥} denotes the dielectric constant perpendicular thereto).

The electro-optical data are measured in a TN cell at the 1st minimum (i.e. at a d−Δn value of 0.5 μm) at 20° C., unless expressly indicated otherwise. The optical data are measured at 20° C., unless expressly indicated otherwise. All physical properties are determined in accordance with “Merck Liquid Crystals, Physical Properties of Liquid Crystals”, status November 1997, Merck KGaA, Germany, and apply for a temperature of 20° C., unless explicitly indicated otherwise.

### EXAMPLE M1

| | | | |
|---|---|---|---|
| CC-4-V | 25.00% | Clearing point [° C.]: | 77.0 |
| CC-3-V1 | 15.00% | | |
| CCQU-3-F | 11.50% | | |
| PUQU-3-F | 15.00% | | |
| PGP-2-5 | 2.00% | | |
| CPGU-3-OT | 8.50% | | |
| PGUQU-3-F | 5.50% | | |
| APUQU-3-F | 8.00% | | |
| CP-1V-01 | 4.00% | | |
| CCP-30CF₃ | 5.50% | | |

### EXAMPLE M2

| | | | |
|---|---|---|---|
| CC-4-V | 25.00% | Clearing point [° C.]: | 73.5 |
| CC-3-V1 | 15.00% | | |
| CCQU-3-F | 11.50% | | |
| PUQU-3-F | 15.00% | | |
| PGP-2-5 | 2.00% | | |
| CPGU-3-OT | 8.50% | | |
| PGUQU-3-F | 5.50% | | |
| APUQU-3-F | 8.00% | | |
| CP-1V-2 | 4.00% | | |
| CCP-30CF₃ | 5.50% | | |

### EXAMPLE M3

| | | | |
|---|---|---|---|
| CC-4-V | 25.00% | Clearing point [° C.]: | 74.0 |
| CC-3-V1 | 15.00% | | |
| CCQU-3-F | 11.50% | | |
| PUQU-3-F | 15.00% | | |
| PGP-2-5 | 2.00% | | |
| CPGU-3-OT | 8.50% | | |
| PGUQU-3-F | 5.50% | | |
| APUQU-3-F | 8.00% | | |
| CP-V2-1 | 4.00% | | |
| CCP-30CF₃ | 5.50% | | |

### EXAMPLE M4

| | | | |
|---|---|---|---|
| CCH-23 | 18.00% | Clearing point [° C.]: | 76.5 |
| PCH-301 | 6.00% | | |
| CP-1V-01 | 3.00% | | |
| PUQU-3-F | 10.00% | | |
| CCQU-3-F | 15.00% | | |
| BCH-3F.F.F | 10.00% | | |
| CCP-30CF₃ | 8.00% | | |
| CCP-50CF₃ | 7.00% | | |
| PGP-2-5 | 6.00% | | |
| APUQU-3-F | 7.00% | | |
| PGUQU-3-F | 7.00% | | |
| CPGU-3-OT | 3.00% | | |

### EXAMPLE M5

| | | | |
|---|---|---|---|
| CCH-23 | 18.00% | Clearing point [° C.]: | 74.0 |
| PCH-301 | 6.00% | | |
| CP-1V-2 | 3.00% | | |
| PUQU-3-F | 10.00% | | |
| CCQU-3-F | 15.00% | | |
| BCH-3F.F.F | 10.00% | | |
| CCP-30CF₃ | 8.00% | | |
| CCP-50CF₃ | 7.00% | | |
| PGP-2-5 | 6.00% | | |
| APUQU-3-F | 7.00% | | |
| PGUQU-3-F | 7.00% | | |
| CPGU-3-OT | 3.00% | | |

### EXAMPLE M6

| | | | |
|---|---|---|---|
| CCH-23 | 18.00% | Clearing point [° C.]: | 74.5 |
| PCH-301 | 6.00% | | |
| CP-V2-1 | 3.00% | | |
| PUQU-3-F | 10.00% | | |
| CCQU-3-F | 15.00% | | |
| BCH-3F.F.F | 10.00% | | |
| CCP-30CF₃ | 8.00% | | |
| CCP-50CF₃ | 7.00% | | |
| PGP-2-5 | 6.00% | | |
| APUQU-3-F | 7.00% | | |
| PGUQU-3-F | 7.00% | | |
| CPGU-3-OT | 3.00% | | |

### EXAMPLE M7

| | | | |
|---|---|---|---|
| BCH-32 | 5.00% | LTS bulk [−20° C.]: | >1000 h |
| PUQU-3-F | 7.50% | | |
| PGP-2-3 | 6.50% | | |
| PGP-2-4 | 6.50% | | |
| PGP-2-5 | 8.00% | | |
| CCQU-2-F | 2.00% | | |
| CCQU-3-F | 3.00% | | |
| CCQU-5-F | 2.50% | | |
| PCH-301 | 17.50% | | |
| CP-1V-2 | 4.50% | | |
| CCH-23 | 13.50% | | |
| CCH-34 | 7.00% | | |
| CPGU-3-OT | 5.50% | | |
| CCGU-3-F | 5.50% | | |
| PGUQU-3-F | 5.50% | | |

### EXAMPLE M8

| | | | |
|---|---|---|---|
| BCH-32 | 5.00% | Clearing point [° C.]: | 75.0 |
| PUQU-3-F | 7.50% | | |
| PGP-2-3 | 6.50% | | |
| PGP-2-4 | 6.50% | | |
| PGP-2-5 | 8.00% | | |
| CCQU-2-F | 2.00% | | |
| CCQU-3-F | 3.00% | | |
| CCQU-5-F | 2.50% | | |
| PCH-301 | 17.50% | | |
| CP-V2-1 | 4.50% | | |
| CCH-23 | 13.50% | | |
| CCH-34 | 7.00% | | |
| CPGU-3-OT | 5.50% | | |
| CCGU-3-F | 5.50% | | |
| PGUQU-3-F | 5.50% | | |

### EXAMPLE M9

| | | | |
|---|---|---|---|
| APUQU-3-F | 11.50% | Clearing point [° C.]: | 74.5 |
| BCH-3F.F.F | 21.00% | Δn [589 nm, 20° C.] | 0.1304 |
| CC-3-V | 19.00% | | |
| CCGU-3-F | 3.50% | | |
| CCP-1F.F.F | 3.00% | | |
| CCP-2F.F.F | 6.00% | | |
| CCP-V-1 | 2.00% | | |
| CP-V2-1 | 1.00% | | |
| CPGP-5-2 | 1.00% | | |
| CPGU-3-OT | 8.50% | | |
| PGP-2-4 | 4.50% | | |
| PP-1-2V1 | 3.00% | | |
| PPGU-3-F | 2.00% | | |
| PUQU-3-F | 14.00% | | |

### EXAMPLE M10

| | | | |
|---|---|---|---|
| APUQU-2-F | 8.50% | Clearing point [° C.]: | 74.7 |
| APUQU-3-F | 8.50% | Δn [589 nm, 20° C.] | 0.1269 |
| CC-3-V | 27.50% | | |
| CCGU-3-F | 8.50% | | |
| PGP-2-2V | 9.00% | | |
| CCQU-3-F | 7.50% | | |
| CCGU-3-OT | 4.50% | | |
| PP-1-2V1 | 3.50% | | |
| PPGU-3-F | 0.50% | | |
| PUQU-3-F | 19.00% | | |
| CP-V2-1 | 3.00% | | |

### EXAMPLE M11

| | | | |
|---|---|---|---|
| APUQU-2-F | 7.75% | Clearing point [° C.]: | 73.9 |
| APUQU-3-F | 7.75% | Δn [589 nm, 20° C.] | 0.1359 |
| CC-3-V | 21.00% | | |
| CCGU-3-F | 9.00% | | |
| PGP-2-2V | 8.00% | | |
| PGP-2-5 | 3.50% | | |
| CCQU-3-F | 8.00% | | |
| CPGU-3-OT | 4.50% | | |
| PP-1-2V1 | 5.50% | | |
| PPGU-3-F | 0.50% | | |
| PUQU-3-F | 19.50% | | |
| CP-V2-1 | 5.00% | | |

### EXAMPLE M12

| | | | |
|---|---|---|---|
| APUQU-2-F | 7.50% | Clearing point [° C.]: | 80.1 |
| APUQU-3-F | 7.50% | Δn [589 nm, 20° C.] | 0.1351 |
| CC-3-V | 18.50% | | |
| CCGU-3-F | 9.00% | | |
| PGP-2-2V | 6.50% | | |
| PGP-2-5 | 4.00% | | |
| CCQU-3-F | 8.00% | | |
| CPGU-3-OT | 4.50% | | |
| PP-1-2V1 | 4.00% | | |
| PPGU-3-F | 0.50% | | |
| PUQU-3-F | 20.00% | | |
| CP-V2-1 | 5.00% | | |
| CCP-V2-1 | 5.00% | | |

### EXAMPLE M13

| | | | |
|---|---|---|---|
| APUQU-2-F | 7.50% | Clearing point [° C.]: | 77.4 |
| APUQU-3-F | 7.50% | Δn [589 nm, 20° C.] | 0.1355 |
| CC-3-V | 21.00% | | |
| CCGU-3-F | 8.50% | | |
| PGP-2-2V | 7.00% | | |
| PGP-2-5 | 3.50% | | |
| CCQU-3-F | 7.00% | | |
| CPGU-3-OT | 5.00% | | |
| PP-1-2V1 | 3.00% | | |
| PPGU-3-F | 0.50% | | |
| PUQU-3-F | 18.00% | | |
| CP-V2-1 | 5.00% | | |
| CPU-3-OXF | 6.50% | | |

### EXAMPLE M14

| | | | |
|---|---|---|---|
| APUQU-2-F | 8.25% | Clearing point [° C.]: | 74.8 |
| APUQU-3-F | 8.25% | Δn [589 nm, 20° C.] | 0.1167 |
| CC-3-V | 32.00% | | |
| CCGU-3-F | 5.50% | | |
| PGP-2-2V | 6.00% | | |
| CCQU-3-F | 12.00% | | |
| CPGU-3-OT | 6.00% | | |
| PP-1-2V1 | 1.50% | | |
| PPGU-3-F | 1.00% | | |
| PUQU-3-F | 18.00% | | |
| CP-V2-1 | 1.50% | | |

### EXAMPLE M15

| | | | |
|---|---|---|---|
| APUQU-2-F | 7.00% | Clearing point [° C.]: | 74.8 |
| APUQU-3-F | 7.25% | Δn [589 nm, 20° C.] | 0.1337 |
| CC-3-V | 24.50% | | |
| CCGU-3-F | 8.00% | | |
| PGP-2-2V | 6.50% | | |
| PGP-2-5 | 2.00% | | |
| CPGU-3-OT | 5.50% | | |
| PP-1-2V1 | 1.75% | | |
| PPGU-3-F | 0.50% | | |
| PUQU-3-F | 18.50% | | |
| CP-V2-1 | 5.00% | | |
| CPU-3-OXF | 13.50% | | |

### EXAMPLE M16

| | | | |
|---|---|---|---|
| APUQU-2-F | 7.50% | Clearing point [° C.]: | 76.8 |
| APUQU-3-F | 7.50% | Δn [589 nm, 20° C.] | 0.1351 |
| CC-3-V | 22.00% | | |
| CCGU-3-F | 8.50% | | |
| PGP-2-2V | 8.00% | | |
| PGP-2-5 | 3.50% | | |
| CCQU-3-F | 7.50% | | |
| CPGU-3-OT | 6.00% | | |
| PP-1-2V1 | 3.50% | | |
| PPGU-3-F | 0.50% | | |
| PUQU-3-F | 19.00% | | |
| CP-V2-1 | 5.00% | | |
| CPU-3-OXF | 1.50% | | |

### EXAMPLE M17

| | |
|---|---|
| APUQU-2-F | 7.00% |
| APUQU-3-F | 7.25% |
| CC-3-V | 23.25% |
| CCGU-3-F | 8.00% |
| PGP-2-2V | 6.50% |
| PGP-2-5 | 2.00% |
| CPGU-3-OT | 5.50% |
| PP-1-2V1 | 3.00% |
| PPGU-3-F | 0.50% |
| PUQU-3-F | 18.50% |
| CP-V2-1 | 5.00% |
| CPU-3-OXF | 13.50% |

1. Liquid-crystalline medium, characterised in that it comprises one or more compounds of the formula I, 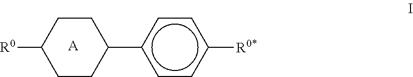
in which
R⁰ and R⁰* each, independently of one another, denote an alkyl or alkoxy radical having 1 to 15 C atoms, where, in addition, one or more CH₂ groups in these radicals may each be replaced, independently of one another, by —C≡C—, —CF₂O—, —CH═CH—, 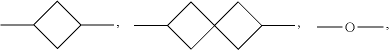
—CO—O—, —O—CO— in such a way that O atoms are not linked directly to one another, and in which, in addition, one or more H atoms may be replaced by halogen,
ring A denotes a 1,4-cyclohexylene ring or 1,4-cyclohexenylene ring, in which, in addition, one or two CH₂ groups may be replaced by —O— and/or —S—.

2. Liquid-crystalline medium according to claim 1, characterised in that it comprises one or more compounds of the formulae 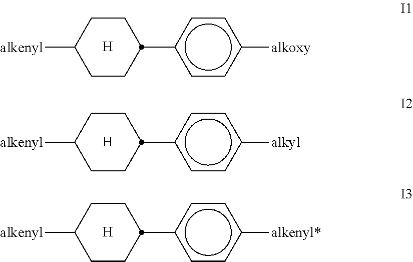
in which
alkenyl and alkenyl* each, independently of one another, denote a straight-chain alkenyl radical having 2 to 6 C atoms,
alkoxy denotes a straight-chain alkoxy radical having 1 to 6 C atoms
and
alkyl denotes a straight-chain alkyl radical having 1 to 6 C atoms.

3. Liquid-crystalline medium according to claim 1, characterised in that it comprises one or more compounds of the formulae

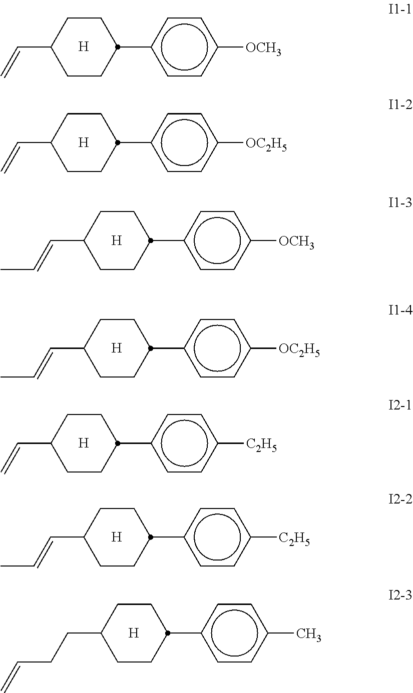

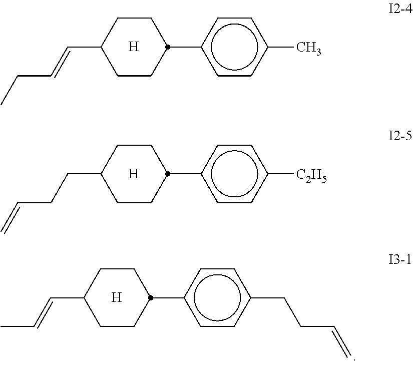

4. Liquid-crystalline medium according to claim 1, characterised in that it comprises at least one compound from the group of the compounds of the formulae I2-2, I2-3 and I2-4,

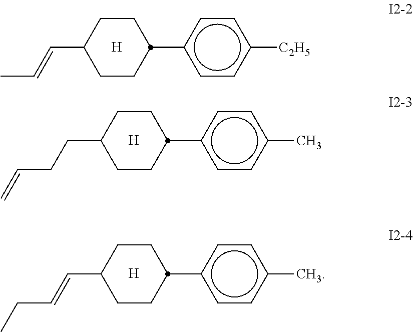

5. Liquid-crystalline medium according to claim 1, characterised in that it additionally comprises one or more compounds of the formulae II and/or III, 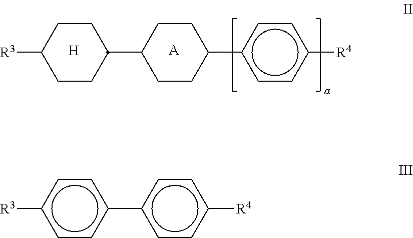
in which
Ring A denotes 1,4-phenylene or trans-1,4-cyclohexylene,
a is 0 or 1, where, in the case where a=0, ring A denotes trans-1,4-cyclohexylene,
R³ denotes alkenyl having 2 to 9 C atoms,
and
R⁴ has the meanings indicated for R⁰ in claim 1.

6. Liquid-crystalline medium according to claim 1, characterised in that it additionally comprises one or more compounds selected from the compounds of the formulae 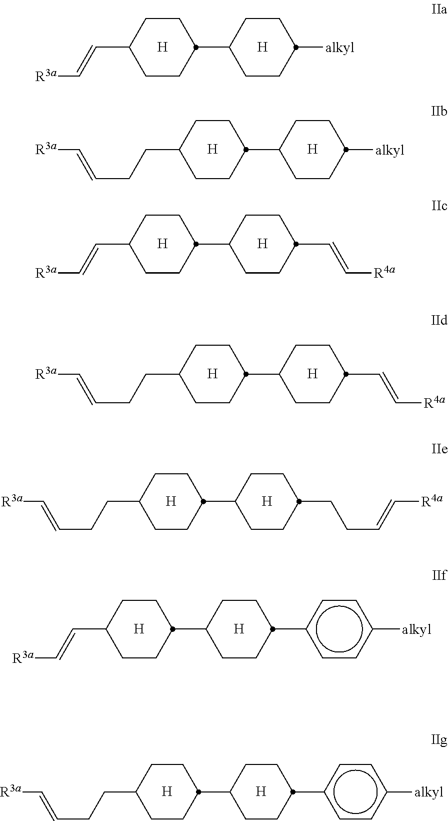 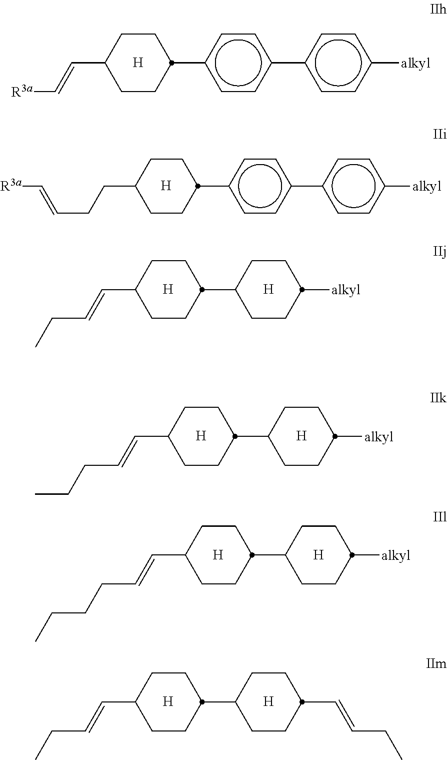 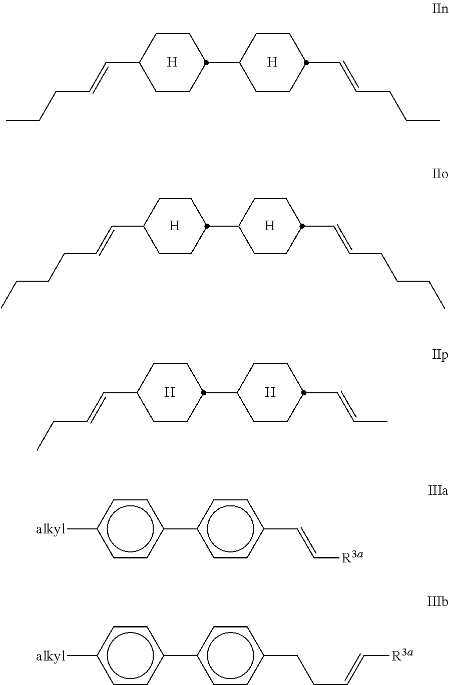
in which R^{3a} and R^{4a} each, independently of one another, denote H, CH₃, C₂H₅ or C₃H₇, and “alkyl” denotes a straight-chain alkyl group having 1 to 8 C atoms.

7. Liquid-crystalline medium according to claim 1, characterised in that it additionally comprises one or more compounds selected from the compounds of the formulae IV to VIII, 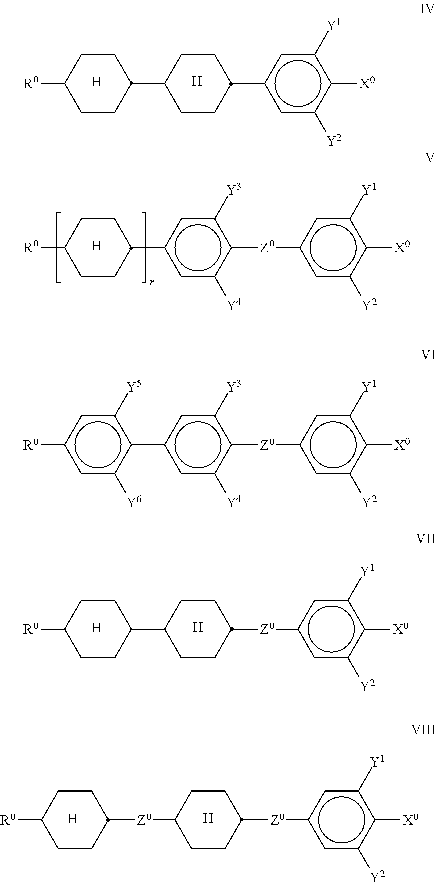
in which
R⁰ denotes an alkyl or alkoxy radical having 1 to 15 C atoms, where, in addition, one or more CH₂ groups in these radicals may each be replaced, independently of one another, by —C≡C—, —CF₂O—, —CH═CH—, 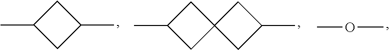
—CO—O— or —O—CO— in such a way that O atoms are not linked directly to one another, and in which, in addition, one or more H atoms may be replaced by halogen,
X⁰ denotes F, Cl, a mono- or polyfluorinated alkyl or alkoxy radical having 1 to 6 C atoms or a mono- or polyfluorinated alkenyl or alkenyloxy radical having 2 to 6 C atoms,
Y¹⁻⁶ each, independently of one another, denote H or F,
Z⁰ denotes —C₂H₄—, —(CH₂)₄—, —CH═CH—, —CF═CF—, —C₂F₄—, —CH₂CF₂—, —CF₂CH₂—, —CH₂O—, —OCH₂—, —COO—, —CF₂O— or —OCF₂—, in the formulae V and VI also a single bond, and
r denotes 0 or 1.

8. Liquid-crystalline medium according to claim 7, characterised in that it additionally comprises one or more compounds selected from the compounds of the formulae Va to Vj,

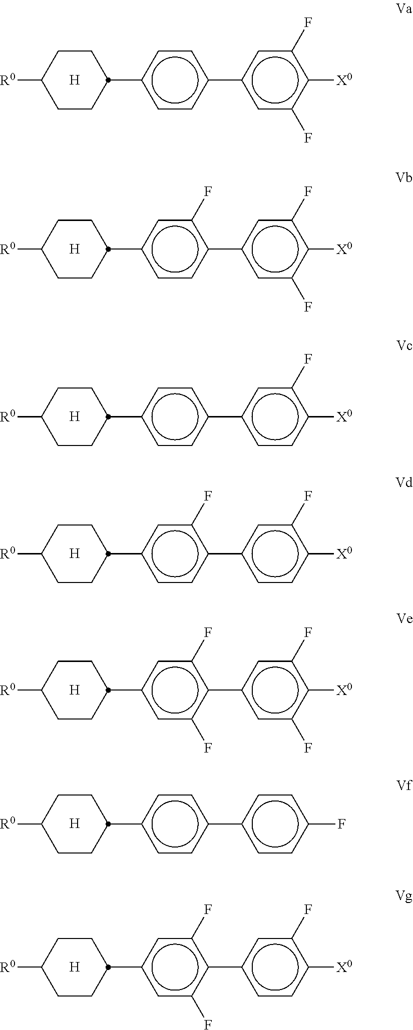

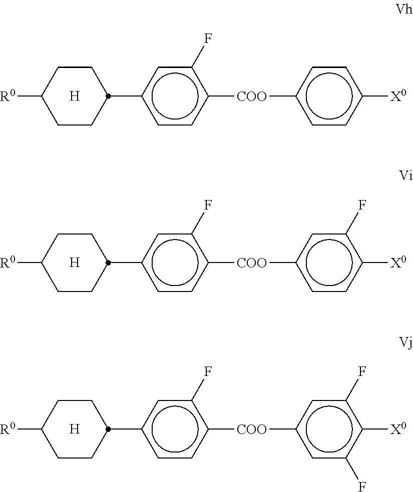

9. Liquid-crystalline medium according to claim 7, characterised in that it additionally comprises one or more compounds selected from the compounds of the formulae VI-1a to VI-1d,

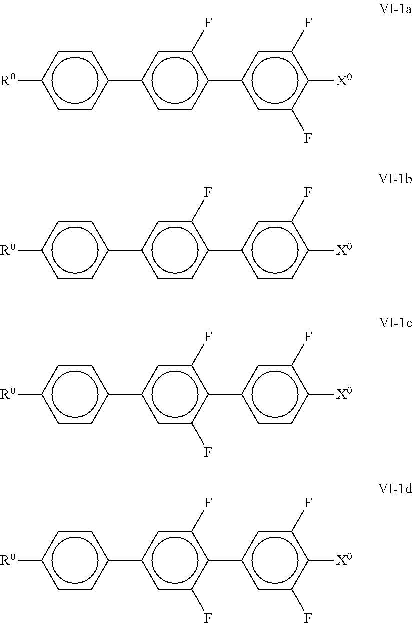

10. Liquid-crystalline medium according to claim 7, characterised in that it additionally comprises one or more compounds selected from the compounds of the formulae VI-2a to VI-2f,

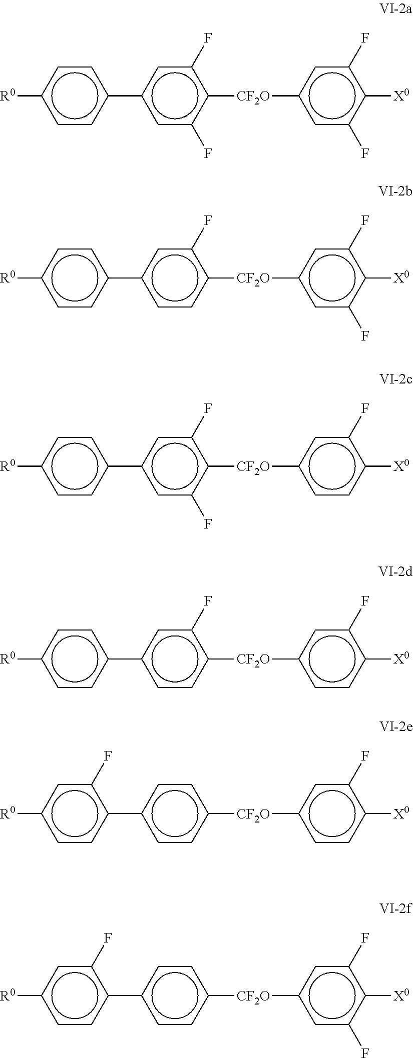

11. Liquid-crystalline medium according to claim 7, characterised in that it additionally comprises one or more compounds selected from the compounds of the formulae X and/or XI, 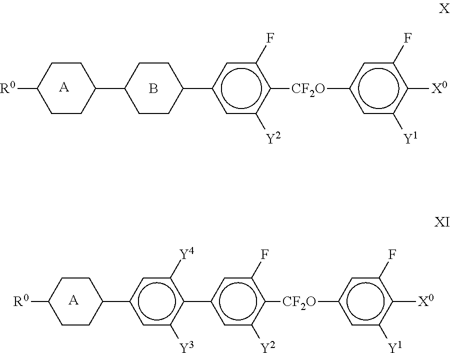
in which
Y¹⁻⁴ each, independently of one another, denote H or F, and 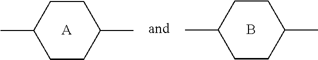
each, independently of one another,

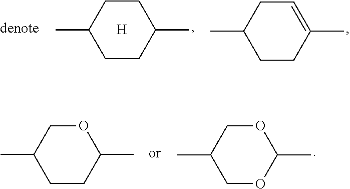

12. Liquid-crystalline medium according to claim 1, characterised in that it additionally comprises one or more compounds selected from the compounds of the formula XII, 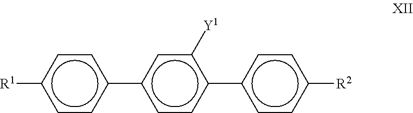
in which
R¹ and R² each, independently of one another, denote n-alkyl, alkoxy, oxaalkyl, fluoroalkyl, alkenyloxy or alkenyl, each having up to 9 C atoms, and Y¹ denotes H or F.

13. Liquid-crystalline medium according to claim 7, characterised in that it additionally comprises one or more compounds selected from the compounds of the formulae XIII to XVI,

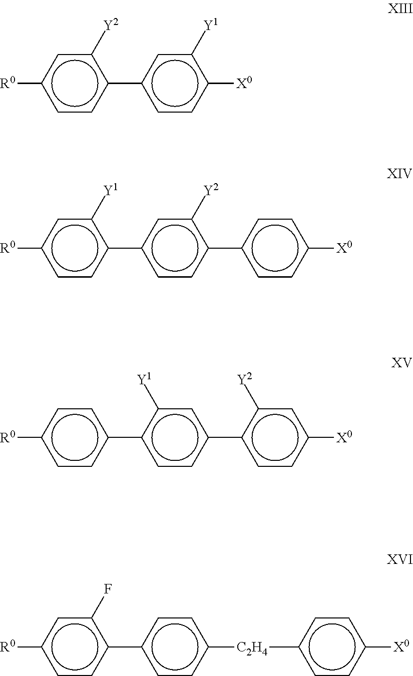

14. Liquid-crystalline medium according to claim 7, characterised in that it additionally comprises one or more tetracyclic compounds selected from the formulae XIX to XXVII,

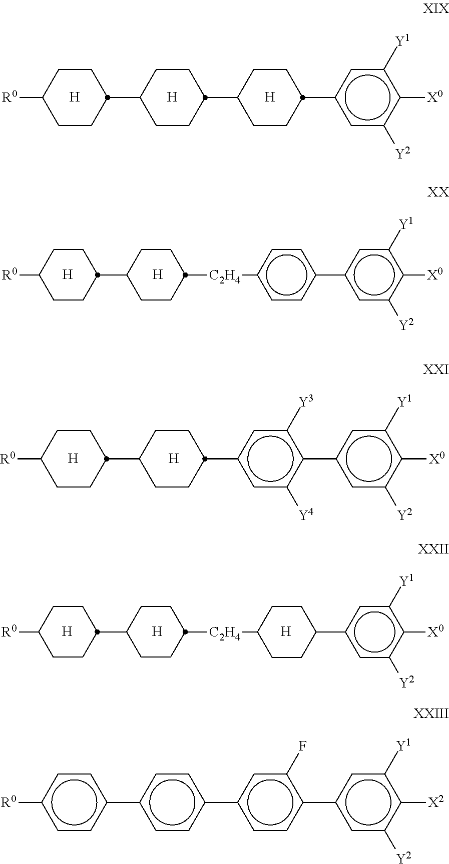

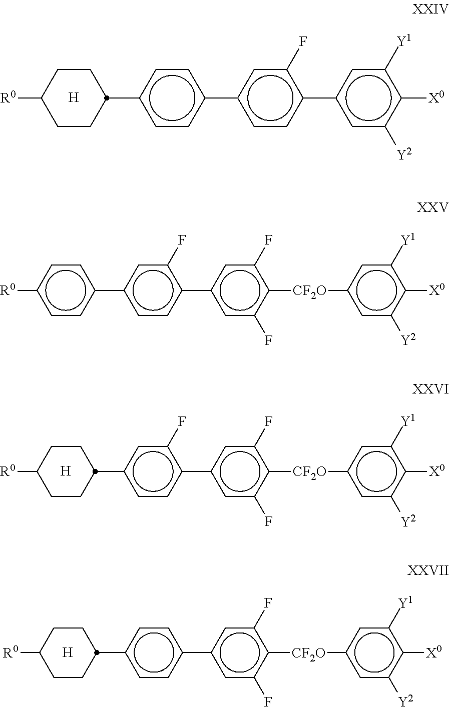

15. Liquid-crystalline medium according to claim 1, characterised in that it comprises 1-25% by weight of compounds of the formula I.

16. Liquid-crystalline medium according to claim 1, characterised in that it additionally comprises one or more UV stabilisers and/or antioxidants.

17. Use of a liquid-crystalline medium according to claim 1 for electro-optical purposes.

18. Use of a liquid-crystalline medium according to claim 17 in TN-TFT, OCB, IPS, FFS, positive VA, PS-TN-TFT, PS-IPS, PS-FFS displays.

19. Electro-optical liquid-crystal display containing a liquid-crystalline medium according to claim 1.

20. Process for the preparation of a liquid-crystalline medium according to claim 1, characterised in that one or more compounds of the formula I are mixed with at least one further mesogenic compound and optionally one or more additives and optionally one or more mesogenic compounds.

21. Compounds of the formulae I2-2, I2-3 and I2-4: [chemical structure]
